(19) United States
(12) Patent Application Publication
(10) Pub. No.: US 2024/0267891 A1
(43) Pub. Date: Aug. 8, 2024

(54) POWER SAVING TECHNIQUE FOR UE TRANSMITTING PERIODIC TRAFFIC

(71) Applicant: QUALCOMM Incorporated, San Diego, CA (US)

(72) Inventors: Hui GUO, Beijing (CN); Tien Viet NGUYEN, Bridgewater, NJ (US); Shuanshuan WU, San Diego, CA (US); Kapil GULATI, Belle Mead, NJ (US); Gabi SARKIS, San Diego, CA (US); Sourjya DUTTA, San Diego, CA (US)

(21) Appl. No.: 18/566,507

(22) PCT Filed: Apr. 8, 2022
(86) PCT No.: PCT/CN2022/085717

§ 371 Date: Dec. 1, 2023

(30) Foreign Application Priority Data
Aug. 16, 2021 (WO) PCT/CN2021/112688
Aug. 16, 2021 (WO) PCT/CN2021/112731

(51) Int. Cl. H04W 72/02; H04B 17/318; H04W 72/0446; H04W 72/11; H04W 72/25; H04W 72/40

(52) U.S. Cl. CPC H04W 72/02; H04B 17/328; H04W 72/0446; H04W 72/11; H04W 72/25; H04W 72/40

(57) ABSTRACT

To provide more power efficient SPS transmission for sidelink UEs, methods, apparatuses, and computer-readable medium are provided. An example method may include selecting a first sidelink transmission resource for SPS based on a sidelink sensing procedure for UE-to-UE communication, the first sidelink transmission resource being associated with one or more subchannels within one or more slots. The example method may further include initiating a timer based on a timer range, the timer range being based on one or more of a battery level or a mobility associated with the UE. The example method may further include reselecting a second sidelink transmission resource or maintain the first sidelink transmission resource for the UE-to-UE communication upon an expiration of the timer.

### CROSS REFERENCE TO RELATED APPLICATION(S)

This application claims the benefit of and priority to International Application No. PCT/CN2021/112731, entitled “POWER SAVING TECHNIQUE FOR UE TRANSMITTING PERIODIC TRAFFIC” and filed on Aug. 16, 2021, and International Application No. PCT/CN2021/112688, entitled “ADAPT RANDOM SELECTION RESOURCES” and filed on Aug. 16, 2021, each of which is expressly incorporated by reference herein in its entirety.

### TECHNICAL FIELD

The present disclosure relates generally to communication systems, and more particularly, to wireless communication systems with semi-persistent scheduling (SPS).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. The memory and the at least one processor coupled to the memory may be configured to select a first sidelink transmission resource for semi-persistent scheduling (SPS) based on a sidelink sensing procedure for UE-to-UE communication. The first sidelink transmission resource may be associated with one or more subchannels within one or more slots. The memory and the at least one processor coupled to the memory may be further configured to initiate a timer based on a timer range. The timer range may be based on one or more of a battery level or a mobility associated with the UE. The memory and the at least one processor coupled to the memory may be further configured to initiate a timer based on a timer range. The timer range may be based on one or more of a battery level or a mobility associated with the UE.

In another aspect of the disclosure, a method, a computer-readable medium, and an apparatus at a user equipment (UE) are provided. The apparatus may include a memory and at least one processor coupled to the memory. The memory and the at least one processor coupled to the memory may be configured to select randomly a resource in a random selection resource set including one or more subchannels within one or more slots. The random selection resource set may be within a sidelink resource pool for UE-to-UE communication and may be available for a sidelink sensing procedure for the UE-to-UE communication. The memory and the at least one processor coupled to the memory may be further configured to transmit a sidelink transmission in the resource.

In another aspect of the disclosure, a method, a computer-readable medium, and an apparatus at a UE are provided. The apparatus may include a memory and at least one processor coupled to the memory. The memory and the at least one processor coupled to the memory may be configured to measure reference signal received power (RSRP) associated with a set of resources within a sidelink resource pool. The memory and the at least one processor coupled to the memory may be further configured to select a first subset of resources associated with a first RSRP above a first threshold within the set of resources or select a second subset of resources associated with a second RSRP above a second threshold within the set of resources. The first subset of resources may be outside a random selection resource set available for one or more random selection UEs, the second subset of resources may be within the random selection resource set. The memory and the at least one processor coupled to the memory may be further configured to transmit a sidelink transmission using the first subset of resources or the second subset of resources.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 illustrates example aspects of a sidelink slot structure.

FIG. 3 is a diagram illustrating an example of a base station and user equipment (UE) in an access network.

FIG. 4 illustrates example aspects of sidelink communication between devices, in accordance with aspects presented herein.

FIGS. 5A and 5B illustrate examples of resource reservation for sidelink communication.

FIG. 6 is an example time diagram for sidelink resource selection.

FIG. 7 is an example diagram illustrating sidelink resource selection, including random selection, partial sensing, and full sensing.

FIG. 8 is an example diagram illustrating sidelink semi-persistent scheduling (SPS) resource selection and reselection.

FIG. 9 is an example diagram illustrating modifying timer range or probability range for sidelink SPS resource selection based on battery level or mobility.

FIG. 10 is another example diagram illustrating modifying timer range or probability range for sidelink SPS resource selection based on battery level or mobility.

FIG. 11 is a communication flow between a base station and UEs that includes sidelink SPS resource selection and reselection.

FIG. 12 is an example diagram illustrating sidelink resource selection, including random selection, partial sensing, and full sensing.

FIG. 13 is an example diagram illustrating a random selection resource set and sidelink resource pool.

FIG. 14 is an example diagram illustrating a UE's reservation in a random selection resource set.

FIG. 15 is an example diagram illustrating the adjustment of a period associated with a random selection resource set.

FIG. 16 is a communication flow between a base station and UEs that may perform random selection and sensing.

FIG. 17 is a flowchart of a method of wireless communication.

FIG. 18 is a flowchart of a method of wireless communication.

FIG. 19 is a diagram illustrating an example of a hardware implementation for an example apparatus.

FIG. 20 is a flowchart of a method of wireless communication.

FIG. 21 is a flowchart of a method of wireless communication.

FIG. 22 is a diagram illustrating an example of a hardware implementation for an example apparatus.

FIG. 23 is a flowchart of a method of wireless communication.

FIG. 24 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

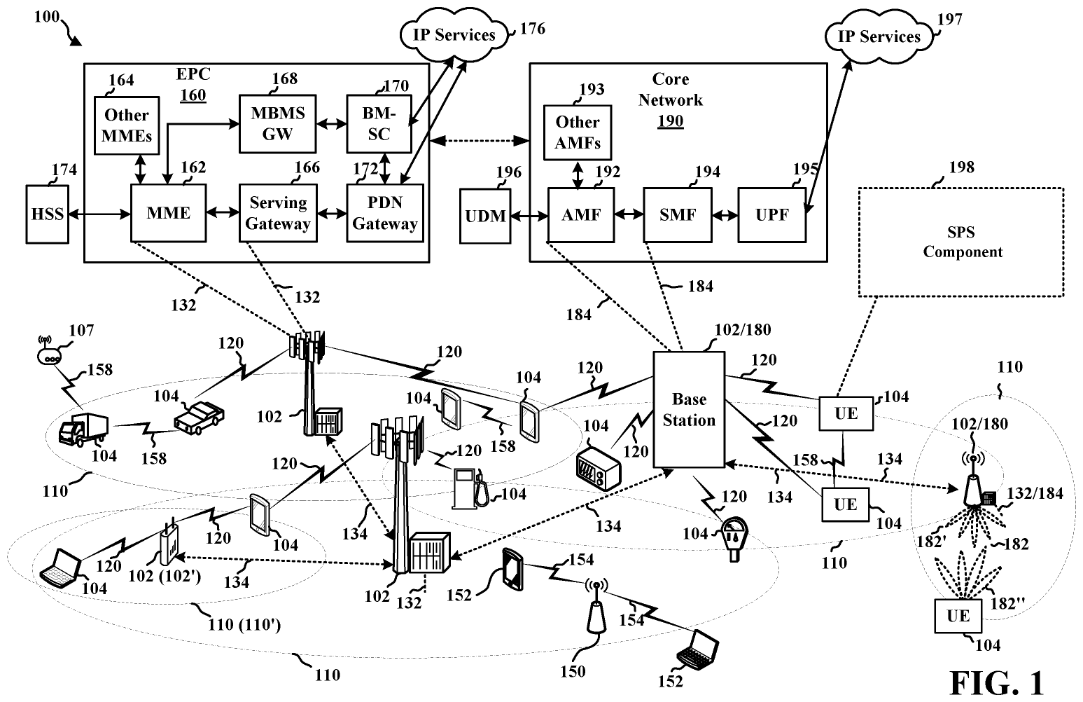

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

A link between a UE 104 and a base station 102 or 180 may be established as an access link, e.g., using a Uu interface. Other communication may be exchanged between wireless devices based on sidelink. For example, some UEs 104 may communicate with each other directly using a device-to-device (D2D) communication link 158. In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

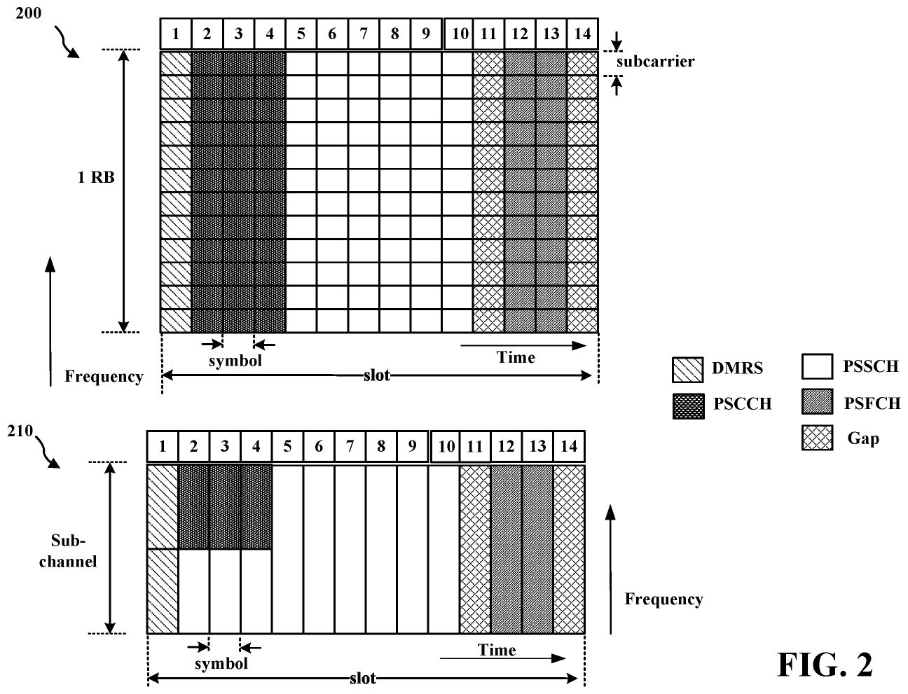

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 2. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

In FIG. 1, the UE 104 may include an SPS component 198. The SPS component 198 may be configured to select a first sidelink transmission resource for SPS based on a sidelink sensing procedure for UE-to-UE communication. The first sidelink transmission resource may be associated with one or more subchannels within one or more slots. The SPS component 198 may be further configured to initiate a timer based on a timer range. The timer range may be based on one or more of a battery level or a mobility associated with the UE. The mobility may be a speed or a velocity associated with the UE. The SPS component 198 may be further configured to reselect to a second sidelink transmission resource or maintain the first sidelink transmission resource for the UE-to-UE communication upon expiration of the timer.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHZ). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming. Similarly, beamforming may be applied for sidelink communication, e.g., between UEs.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although this example is described for the base station 180 and UE 104, the aspects may be similarly applied between a first and second device (e.g., a first and second UE) for sidelink communication.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The physical sidelink shared channel (PSSCH) may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The PSSCH occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include control information in PSCCH and some REs may include demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 2. Multiple slots may be aggregated together in some aspects.

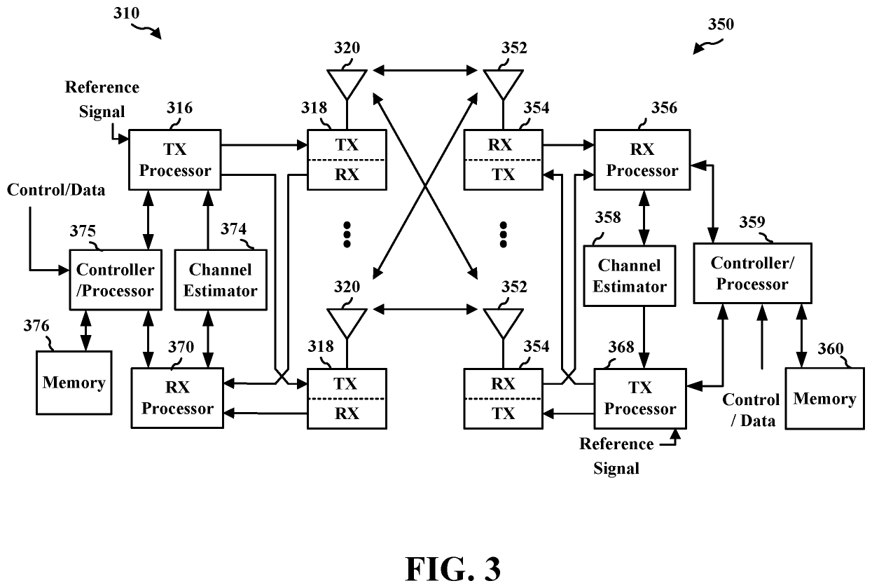

FIG. 3 is a block diagram of a first wireless communication device 310 in communication with a second wireless communication device 350 based on sidelink. In some examples, the devices 310 and 350 may communicate based on V2X or other D2D communication. The communication may be based on sidelink using a PC5 interface. The devices 310 and the 350 may comprise a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318TX. Each transmitter 318TX may modulate an RF carrier with a respective spatial stream for transmission.

At the device 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an acknowledgment (ACK) and/or negative ACK (NACK) protocol to support hybrid automatic repeat request (HARQ) operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The transmission is processed at the device 310 in a manner similar to that described in connection with the receiver function at the device 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368/316, the RX processor 356/370, and the controller/processor 359/375 may be configured to perform aspects in connection with the SPS component 198 of FIG. 1.

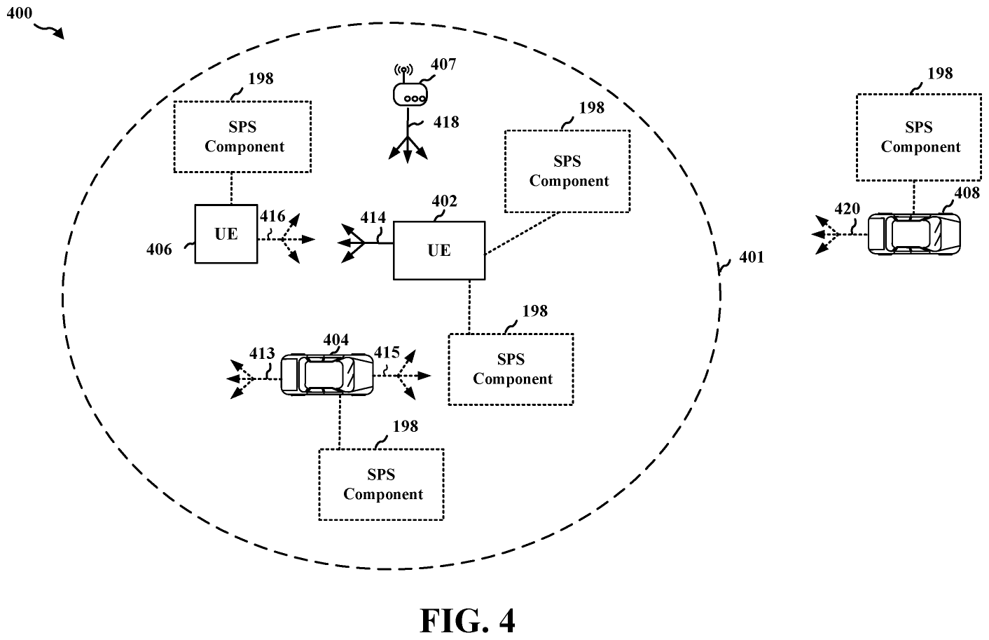

FIG. 4 illustrates an example 400 of sidelink communication between devices. The communication may be based on a slot structure including aspects described in connection with FIG. 2. For example, the UE 402 may transmit a sidelink transmission 414, e.g., including a control channel (e.g., PSCCH) and/or a corresponding data channel (e.g., PSSCH), that may be received by UEs 404, 406, 408. A control channel may include information (e.g., sidelink control information (SCI)) such as information about time and/or frequency resources that are reserved for the data channel transmission. In one example, other UEs may measure reference signal received power (RSRP) and may avoid transmitting in the resources based on the measured RSRP. For example, the SCI may indicate a number of TTIs, as well as the RBs that will be occupied by the data transmission. The SCI may also be used by receiving devices to avoid interference by refraining from transmitting on the reserved resources. The UEs 402, 404, 406, 408 may each be capable of sidelink transmission in addition to sidelink reception. Thus, UEs 404, 406, 408 are illustrated as transmitting sidelink transmissions 413, 415, 416, 420. The sidelink transmissions 413, 414, 415, 416, 420 may be unicast, broadcast or multicast to nearby devices. For example, UE 404 may transmit transmission 413, 415 intended for receipt by other UEs within a range 401 of UE 404, and UE 406 may transmit transmission 416. Additionally/alternatively, RSU 407 may receive communication from and/or transmit transmission 418 to UEs 402, 404, 406, 408. One or more of the UEs 402, 404, 406, 408, or the RSU 407 may include an SPS component 198.

Sidelink communication may be based on different types or modes of resource allocation mechanisms. In a first resource allocation mode (which may be referred to herein as “Mode 1”), centralized resource allocation may be provided by a network entity. For example, a base station 102 or 180 may determine resources for sidelink communication and may allocate resources to different UEs 104 to use for sidelink transmissions. In this first mode, a UE receives the allocation of sidelink resources from the base station 102 or 180. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots (discussed below).

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism (which may also be referred to as a “sensing procedure”, “sidelink sensing procedure”, “sensing-based resource selection”, or the like). For instance, before selecting a resource for a data transmission, a UE may first determine whether resources have been reserved by other UEs.

For example, as part of a sensing mechanism for resource allocation mode 2, the UE may determine (e.g., sense) whether the selected sidelink resource has been reserved by other UE(s) before selecting a sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field included in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

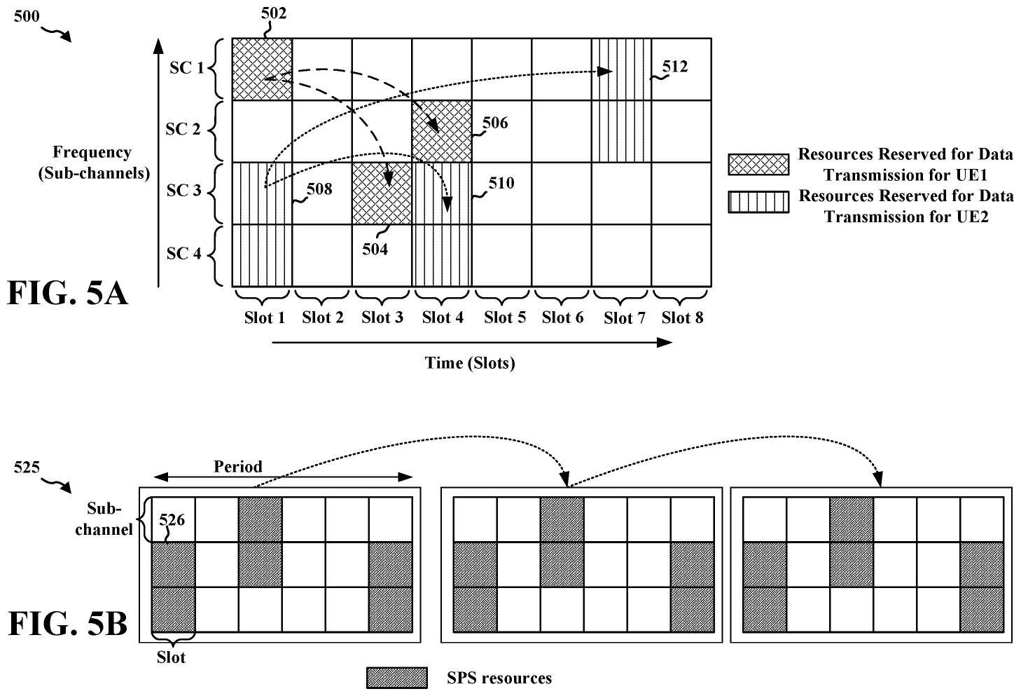

Sidelink resource reservations may be periodic or aperiodic. FIG. 5A illustrates an example 500 of time and frequency resources showing aperiodic reservations for sidelink transmissions. FIG. 5B illustrates an example 525 of periodic reservations for sidelink transmissions. The resources may be included in a sidelink resource pool, for example. The resource allocation for each UE may be in units of one or more sub-channels in the frequency domain (e.g., sub-channels SC 1 to SC 4), and may be based on one slot in the time domain. The UE may also use resources in the current slot to perform an initial transmission, and may reserve resources in future slots for retransmissions. In this example, two different future slots may be reserved by UE1 and UE2 for retransmissions. The resource reservation may be limited to a window of time or slots. The initial candidate set of potential resources for a sidelink transmission may include 8 slots by 4 sub-channels, which provides 32 available resource blocks in total. This window may also be referred to as a resource selection window.

A first UE (“UE1) may reserve a sub-channel (e.g., SC 1) in a current slot (e.g., slot 1) for its initial data transmission 502, and may reserve additional future slots within the window for data retransmissions (e.g., 504 and 506). For example, UE1 may reserve sub-channels SC 3 at slots 3 and SC 2 at slot 4 for future retransmissions as shown by FIG. 4. UE1 then transmits information regarding which resources are being used and/or reserved by it to other UE(s). UE1 may transmit the information by including the reservation information in the reservation resource field of the SCI, e.g., a first stage SCI.

FIG. 5A illustrates that a second UE (“UE2”) reserves resources in sub-channels SC 3 and SC 4 at time slot 1 for its current data transmission 508, and reserve first data retransmission 510 at time slot 4 using sub-channels SC 3 and SC 4, and reserve second data retransmission 512 at time slot 7 using sub-channels SC 1 and SC 2 as shown by FIG. 5A. Similarly, UE2 may transmit the resource usage and reservation information to other UE(s), such as using the reservation resource field in SCI.

A third UE may consider resources reserved by other UEs within the resource selection window to select resources to transmit its data. The third UE may first decode SCIs within a time period to identify which resources are available (e.g., candidate resources). For example, the third UE may exclude the resources reserved by UE1 and UE2 and may select other available sub-channels and time slots from the candidate resources for its transmission and retransmissions, which may be based on a number of adjacent sub-channels in which the data (e.g., packet) to be transmitted can fit.

While FIG. 5A illustrates resources being reserved for an initial transmission and two retransmissions, the reservation may be for an initial transmission and subsequent transmissions or for an initial transmission but not subsequent transmissions.

FIG. 5B illustrates an example 525 of a periodic resource reservation. Periodic resource reservation and signaling may be disabled by configuration. A period with configurable values may be signaled in SCI. As an example, a period may have a value between 0 ms and 1000 ms. Sidelink resources may be reserved periodically, such as for SPS resources. In SPS, initial transmissions of a subsequent period in an SPS flow may be protected by an earlier SPS transmission. FIG. 5B illustrates an initial transmission may indication a resource reservation, e.g., at 526, for the SPS resources.

The UE may determine an associated signal measurement (such as RSRP) for each resource reservation received by another UE. The UE may consider resources reserved in a transmission for which the UE measures an RSRP below a threshold to be available for use by the UE. A UE may perform signal/channel measurement for a sidelink resource that has been reserved and/or used by other UE(s), such as by measuring the RSRP of the message (e.g., the SCI) that reserves the sidelink resource. Based at least in part on the signal/channel measurement, the UE may consider using/reusing the sidelink resource that has been reserved by other UE(s). For example, the UE may exclude the reserved resources from a candidate resource set if the measured RSRP meets or exceeds the threshold, and the UE may consider a reserved resource to be available if the measured RSRP for the message reserving the resource is below the threshold. The UE may include the resources in the candidate resources set and may use/reuse such reserved resources when the message reserving the resources has an RSRP below the threshold, because the low RSRP indicates that the other UE is potentially distant and a reuse of the resources is less likely to cause interference to that UE. A higher RSRP indicates that the transmitting UE that reserved the resources is potentially closer to the UE and may experience higher levels of interference if the UE selected the same resources.

For example, in a first step, the UE may determine a set of candidate resources (e.g., by monitoring SCI from other UEs and removing resources from the set of candidate resources that are reserved by other UEs in a signal for which the UE measures an RSRP above a threshold value). In a second step, the UE may select N resources for transmissions and/or retransmissions of a TB. As an example, the UE may randomly select the N resources from the set of candidate resources determined in the first step. In a third step, for each transmission, the UE may reserve future time and frequency resources for an initial transmission and up to two retransmissions. The UE may reserve the resources by transmitting SCI indicating the resource reservation. For example, in the example in FIG. 5A, the UE may transmit SCI reserving resources for current data transmission 508, first data retransmission 510, and second data retransmission 512.

There may be a timeline for a sensing-based resource selection. For example, the UE may sense and decode the SCI received from other UEs during a sensing window, e.g., a time duration prior to resource selection. Based on the sensing history during the sensing window, the UE may be able to maintain a set of available candidate resources by excluding resources that are reserved by other UEs from the set of candidate resources. A UE may select resources from its set of available candidate resources and transmits SCI reserving the selected resources for sidelink transmission (e.g., a PSSCH transmission) by the UE. There may be a time gap between the UE's selection of the resources and the UE transmitting SCI reserving the resources.

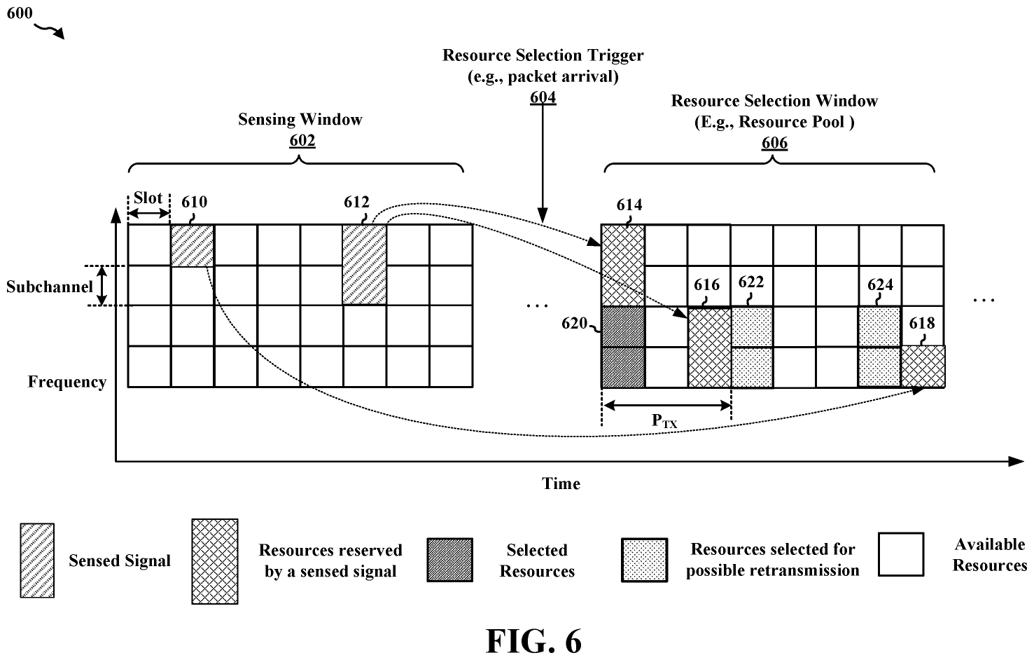

FIG. 6 illustrates an example timeline 600 for sidelink resource selection based on sensing. In FIG. 6, the UE may receive sidelink transmission 610 and sidelink transmission 612 during the sensing window 602. FIG. 6 illustrates an example sensing window including 8 consecutive time slots and 4 consecutive sub-channels, which spans 32 resource blocks. The sidelink transmission 610 indicates a resource reservation for resource 618, and sidelink transmission 612 indicates a resource reservation for resources 614 and 622. For example, the sidelink transmissions 610 and 612 may each include SCI that indicates the corresponding resource reservation. Resource reservations may be periodic or aperiodic. Different reservations of resources may have different priority levels, e.g., with the priority level indicated in the SCI.

A UE receiving the transmissions 610 and 612 may exclude the resources 614, 616, and 618 as candidate resources in a candidate resource set based on the resource selection window 606. In some examples, the sidelink device may exclude the resources 614, 616, or 618 based on whether a measured RSRP for the received SCI (e.g., in 610 or 612) meets a threshold. When a resource selection trigger occurs at 604, such as the sidelink device having a packet for sidelink transmission, the sidelink device may select resources for the sidelink transmission (e.g., including PSCCH and/or PSSCH) from the remaining resources of the resource pool within the resource selection window 606 after the exclusion of the reserved resources (e.g., 614, 616, and 618). FIG. 6 illustrates an example in which the sidelink device selects the resource 620 for sidelink transmission. The sidelink device may also select resources 622 and/or 624 for a retransmission. After selecting the resources for transmission, the sidelink device may transmit SCI indicating a reservation of the selected resources. Thus, each sidelink device may use the sensing/reservation procedure to select resources for sidelink transmissions from the available candidate resources that have not been reserved by other sidelink devices.

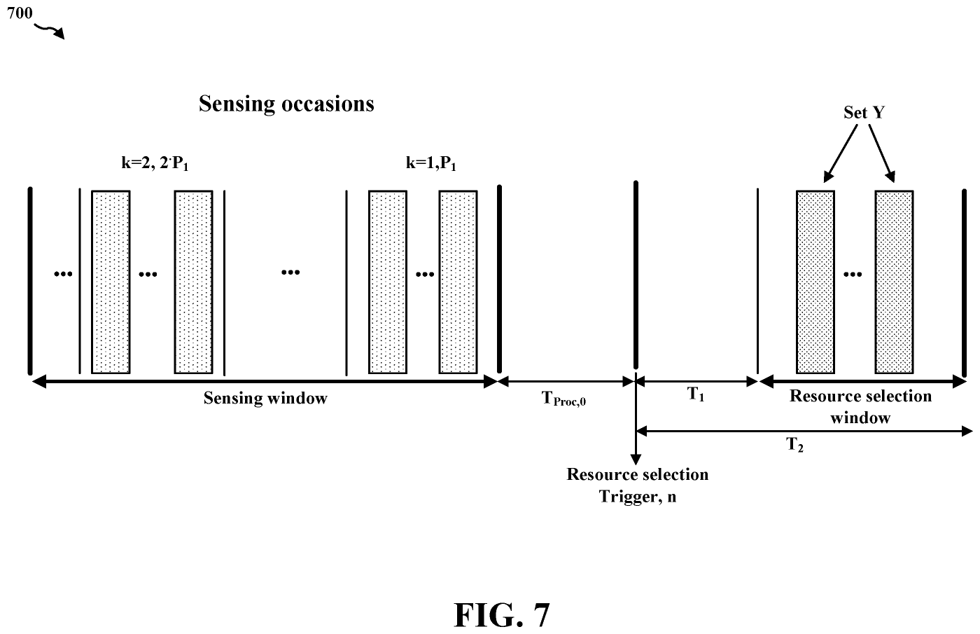

FIG. 7 is an example diagram 700 illustrating sidelink resource selection including random selection, partial sensing, and full sensing. As illustrated in FIG. 7, random selection, partial sensing, and full sensing may be configured for the same resource pool. A sensing procedure based on a sensing window may be referred to as “full sensing,” whereas a sensing procedure based on a shorter sensing window that may be a subsection of the sensing window may be referred to as “partial sensing.” “Random selection” may be used to refer to a procedure where a UE randomly selects a resource within the resource pool without a sensing procedure. In some aspects, for the resource pool in FIG. 7 that may be configured with partial sensing, if a UE performs periodic-based partial sensing, at least when the reservation for another TB (when carried in SCI) is enabled for the resource pool and resource selection/reselection is triggered at slot n, the UE may determine a set of Y candidate slots within a resource selection window. In some aspects, the UE may be subject to conditions for determining the Y candidate slots, and the conditions may be associated with discontinuous reception (DRX) that may be enabled for the UE.

As illustrated in FIG. 7, a resource selection window may be [n+T₁, n+T₂], where T₁≥0 (may be subject to processing time constraint T_{Proc,0}), T₂≤remaining packet delay budget (PDB), and T₂−T₁≤a configured threshold. A UE, such as the UE 402, may be configured to monitor SCI according to one or more sidelink resource reserve periods (which may be represented in a list indicated, for example, by a parameter sl-ResourceReservePeriodList that may include P1 and P2). The UE may also be configured to monitor SCI-based on a configurable subset indicated by a bitmap. The UE may monitor SCI in a most recent (k=1) sensing occasion or a second most recent (k=2) sensing occasion.

A UE, such as the UE 402, may support semi-persistent scheduling (SPS) reservation. For example, the UE may select a resource R at a time r (such as select a resource R based on the sensing procedure). The UE may repeatedly use the resource on r+P, r+2P, . . . , where P is the packet arrival/transmission periodicity. The resource R may be selected relative to a window. At time r and upon the selection, the UE may generate a timer based on a timer range. For example, the timer may be T=N₁ and the timer range may be [5 15], where the number may indicate total times of packet transmission. In some aspects, to generate the timer, the UE may randomly select a value within the timer range. Each value within the timer range may be associated with an equal probability to be selected. After each packet transmission using the resource R, the UE may decrease the timer T by 1. For example, at time r, the timer may be T. At time r+P after another packet transmission using the resource R, the timer may be T−1. At time r+2P after yet another packet transmission using the resource R, the timer may be T−2.

After the timer reaches a threshold, such as 1, the UE may determine whether to keep using the same resource R or reselect a different resource. For example, the UE may randomly generate a probability between 0 to 1. If the randomly generated probability is lower than or equal to a threshold, the UE may maintain (i.e., keep using) the same resource R. If the randomly generated probability is greater than the threshold, the UE may reselect a resource R₂ and may initiate a second timer (e.g., T=N₂ based on the timer range). The UE may then decrease the timer based on packet transmission using the resource R₂. In some aspects, to generate the probability, the UE may randomly select a value between 0 and 1. Each value between 0 and 1 may be associated with an equal probability to be generated.

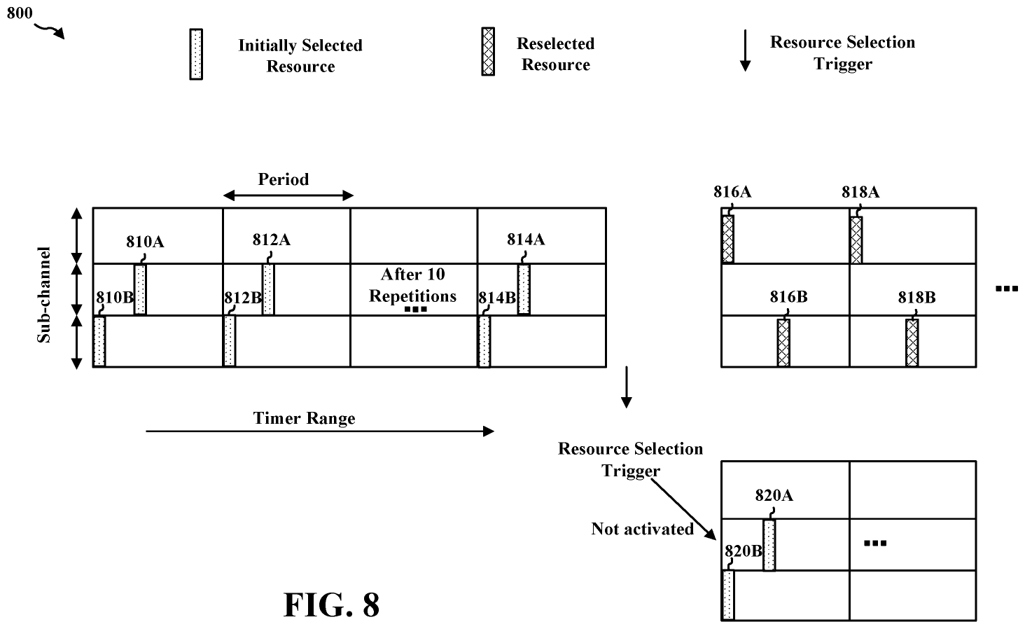

FIG. 8 is an example diagram illustrating sidelink SPS resource selection and reselection. As illustrated in example 800 of FIG. 8, a UE (such as the UE 402) may select a set of resources R, including a resource 810A and a resource 810B. The UE may accordingly initiate a timer T upon selecting the set of resource R. For example, the UE may initiate a first timer of value 13 based on a timer range of [5 15]. The UE may keep using the same set of resource R, which may include resources 812A and 812B, in a subsequent packet transmission period. The timer may be decreased to 12 in the subsequent packet transmission period. After another ten packet transmission periods, the timer may be decreased to 2. After yet another packet transmission period, the UE may still keep using the same set of resource R, which may now include resources 814A and 814B; and the timer may be accordingly decreased to 1. When the timer is decreased to 1, a resource selection trigger may be triggered, and the UE may accordingly generate a probability. If the UE reselects a resource based on the generated probability, the resource selection trigger may be referred to as “active.” If the UE maintains the same resource based on the generated probability, the resource selection trigger may be referred to as “inactive.” As illustrated in FIG. 8, the UE may reselect a different set of resources which may include resources 816A and 816B. The UE may initiate a second timer based on the timer range [5 15]. The UE may use the same set of resources which may include resources 818A and 818B in a subsequent packet transmission period. The UE may maintain the same resource until the next active resource selection trigger.

If the UE maintains the same resource based on the generated probability, the resource selection trigger may be inactive. The UE may use the same set of resources which may include resources 820A and 820B. The UE may maintain the same resource until the next active resource selection trigger.

Example aspects provided herein may save power for a sidelink UE by reducing the number of sensing occasions where an SPS resource reselection is triggered. If a UE maintains the previously selected resource, it may avoid reselecting the resource. The UE may be able to save power by avoiding a power-consuming sensing procedure for reselecting the resource.

In some aspects, the timer range may be adjusted to save power for a UE. For example, the timer range may be changed from [5 15] to a timer range with a larger maximum/minimum value, [T₁ T₂], where T₁>5 or T₂>15. For example, the new timer range may be [5 150], [10 15], [50 150], or the like. The changed timer range may be based on a network configuration or UE implementation. In some aspects, the timer range may be based on a battery level or a level of power-saving. For example, if the battery level is below a threshold, such as 10%, the UE may change the timer range to a larger value to save power. In another example, if the UE is a vulnerable road user (VRU) that may use sidelink transmission to periodically report safety-related information for a long time, the level of power-saving may be defined to be high, and the UE may be using a timer range with a larger maximum/minimum value, such as [50 150].

In some aspects, the timer range may be based on mobility associated with the UE. The mobility may be a speed or a velocity associated with the UE. For example, if the mobility of the UE 402 is low (i.e., the UE 402 is moving at a speed or velocity lower than a threshold), the timer range may be larger so that the UE 402 is more likely to reselect resources less often. If the mobility of the UE 402 is high (i.e., the UE 402 is moving at a speed or velocity higher than a threshold), the timer range may be smaller so that the UE 402 is more likely to reselect resources more often.

In some aspects, the timer range may be based on mobility associated with one or more other UEs that may be nearby (such as the UE 404 and the UE 406). For example, if the mobility of the UE 404 and the UE 406 is low (i.e., the UE 404 and the UE 406 are moving at a speed or velocity lower than a threshold), the timer range may be larger so that the UE 402 is more likely to reselect resources less often. If the mobility of the UE 404 and the UE 406 is high (i.e., the UE 404 and the UE 406 are moving at a speed or velocity higher than a threshold), the timer range may be smaller so that the UE 402 is more likely to reselect resources more often. In some aspects, the UE 402 may receive an indication of the mobility of the UE 404 and the UE 406 via basic safety message (BSM), sensor sharing message, inter-UE coordination message, SCI, or other sidelink messages. The indication of the mobility may indicate speed or velocity of of the UE 404 and the UE 406.

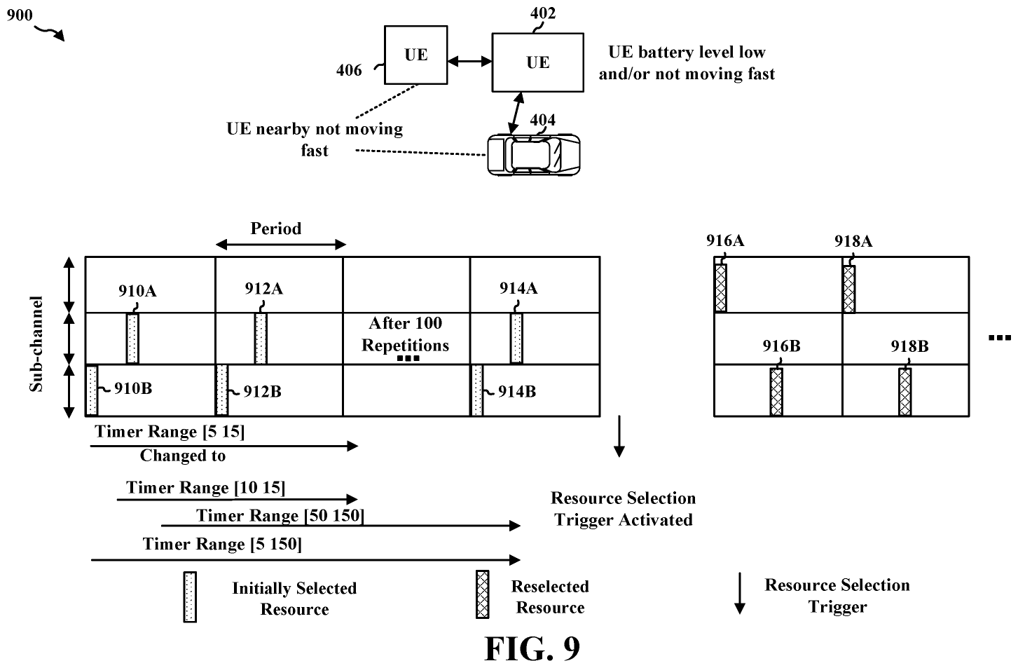

FIG. 9 is an example diagram illustrating modifying timer range or probability range for sidelink SPS resource selection based on battery level or mobility. As illustrated in example 900 of FIG. 9, a UE (such as the UE 402) may select a set of resources R, including a resource 910A and a resource 910B. The UE may accordingly initiate a timer T upon selecting the set of resource R. Based on the battery level, the mobility of the UE, or the mobility of the other UEs, the UE may initiate a timer based on a timer range.

By way of example, the UE may initiate a timer of value 103 based on a timer range of [5 150]. The UE may keep using the same set of resource R, which may include resources 912A and 912B, in a subsequent packet transmission period. The timer may be decreased to 102 in the subsequent packet transmission period. After another one hundred packet transmission periods, the timer may be decreased to 2. After yet another packet transmission period, the UE may maintain the same set of resource R, which may now include resources 914A and 914B; and the timer may be accordingly decreased to 1. When the timer is decreased to 1, a resource selection trigger may be triggered, and the UE may accordingly generate a probability. As illustrated in FIG. 9, based on the generated probability being within a probability range (i.e., lower than or equal to a threshold), the UE may reselect a different set of resources which may include resources 916A and 916B. The UE may initiate a second timer based on the timer range [50 150]. The UE may use the same set of resources which may include resources 918A and 918B in a subsequent packet transmission period. The UE may maintain the same resource until the next active resource selection trigger. In some aspects, if the battery level, mobility, or other conditions have changed, the UE may initiate the second timer based on a different timer range. For example, if the UE is moving faster upon initiating the second timer, the UE may initiate the second timer based on the timer range [5 15].

In some aspects, the probability threshold (which may correspond to a probability range of 0 to the threshold) may be adjusted to save power for a UE. For example, the probability range may be changed from [0, P₁], P₁ equal to one of 0.02, 0.04, 0.06, or 0.08, to [0, P₂] with a larger maximum value, P₂>0.8. For example, P₂ may be one of 0.9, 0.95, 0.99, 0.995, or the like.

The changed probability range may be based on a network configuration or UE implementation. In some aspects, the probability range may be based on a battery level or a level of power-saving. For example, if the battery level is below a threshold, such as 10%, the UE may change the probability range to be associated with a larger maximum value to save power. In another example, if the UE is a vulnerable road user (VRU) that may use sidelink transmission to periodically report safety-related information to an OBU or RSU for a long time, the level of power-saving may be defined to be high, and the UE may be using a probability range with a larger maximum value, such as [0 0.95].

In some aspects, the probability range may be based on mobility associated with the UE. For example, if the mobility of the UE 402 is low (i.e., the UE 402 is moving at a speed or velocity lower than a threshold), the probability range may be larger so that the UE 402 is less likely to reselect resources. If the mobility of the UE 402 is high (i.e., the UE 402 is moving at a speed or velocity higher than a threshold), the probability range may be smaller so that the UE 402 is more likely to reselect resources.

In some aspects, the timer range may be based on mobility associated with one or more other UEs that may be nearby (such as the UE 404 and the UE 406). For example, if the mobility of the UE 404 and the UE 406 is low (i.e., the UE 404 and the UE 406 are moving at a speed or velocity lower than a threshold), the timer range may be larger so that the UE 402 is less likely to reselect resources. If the mobility of the UE 404 and the UE 406 is high (i.e., the UE 404 and the UE 406 are moving at a speed or velocity higher than a threshold), the timer range may be smaller so that the UE 402 is more likely to reselect resources more often. In some aspects, the UE 402 may receive an indication of mobility of the UE 404 and the UE 406 via basic safety message (BSM), sensor sharing message, inter-UE coordination message, SCI, or other sidelink messages. The indication of the mobility may indicate speed or velocity of of the UE 404 and the UE 406.

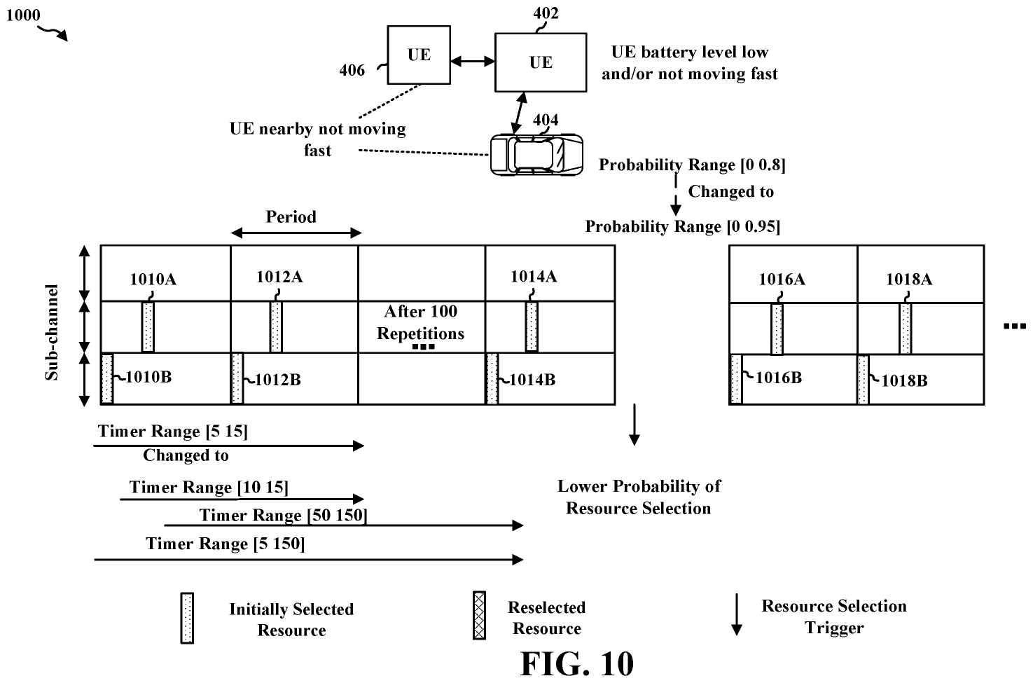

FIG. 10 is an example diagram illustrating modifying timer range or probability range for sidelink SPS resource selection based on battery level or mobility. As illustrated in example 1000 of FIG. 10, a UE (such as the UE 402) may select a set of resources R, including a resource 1010A and a resource 1010B. The UE may accordingly initiate a timer T upon selecting the set of resource R. Based on the battery level, the mobility of the UE, or the mobility of the other UEs, the UE may initiate a timer based on a timer range.

By way of example, the UE may initiate a timer of value 103 based on a timer range of [5 150]. The UE may maintain the same set of resource R, which may include resources 1012A and 1012B, in a subsequent packet transmission period. The timer may be decreased to 102 in the subsequent packet transmission period. After another one hundred packet transmission periods, the timer may be decreased to 2. After yet another packet transmission period, the UE may still maintain the same set of resource R, which may include resources 1014A and 1014B; and the timer may be accordingly decreased to 1. When the timer is decreased to 1, a resource selection trigger may be triggered, and the UE may accordingly generate a probability based on the probability range. For example, the UE may generate a probability based on a random number between 0 and 1. As one example, the UE may generate a probability of value 0.91.

As illustrated in FIG. 10, based on the generated probability being within a probability range of [00.95] (which may be equivalent to lower than or equal to a threshold 0.95), the UE may maintain the same set of resources which may include resources 1016A and 1016B. The UE may initiate a second timer based on the timer range [50 150]. The UE may use the same set of resources which may include resources 1018A and 1018B in a subsequent packet transmission period. The UE may maintain the same resource until the next active resource selection trigger. In some aspects, if the battery level, mobility, or other conditions have changed, the UE may initiate the second timer based on a different timer range. For example, if the UE is moving faster upon initiating the second timer, the UE may initiate the second timer based on the timer range [5 15].

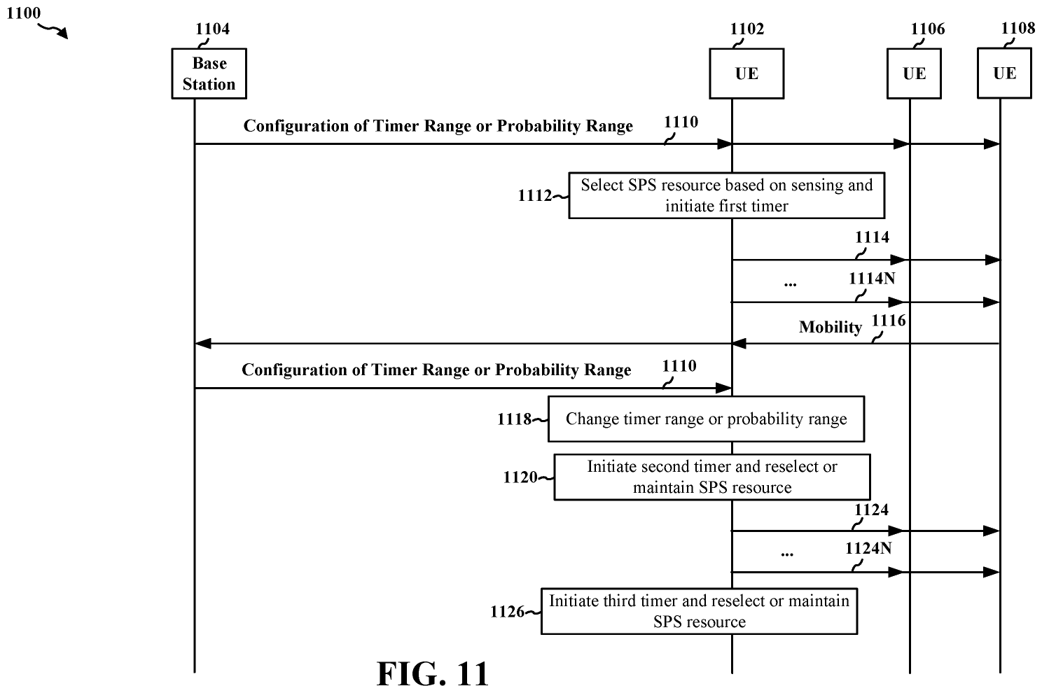

FIG. 11 is a communication flow 1100 between a base station 1104 and UEs 1102, 1106, and 1108 that includes sidelink SPS resource selection and reselection. As illustrated in FIG. 11, the base station 1104 may transmit a configuration of timer range or probability range 1110 to the UEs 1102, 1106, and 1108. At 1112, The UE 1102 may select a set of SPS resources by performing sensing described in connection with FIGS. 5A, 5B, and 6. The UE 1102 may also initiate a first timer based on a timer range described in connection with FIGS. 8-10. The UE 1102 may use the set of SPS resources to periodically transmit packets 1114 and a number of packets 1114N to the UE 1106 or the UE 1108. Upon transmitting a packet 1114 using the set of SPS resources, the UE 1102 may decrease the first timer by one. At 1118, the UE 1102 may change a timer range or a probability range based on a mobility of the UE 1102, a mobility 1116 of the UE 1106 or the UE 1108, or a battery level of the UE 1102. The UE may perform 1118 at any point, such as before or after receiving the configuration of timer range or probability range 1110, before or after selecting SPS resource at 1112, or the like. In some aspects, the UE 1102, the UE 1106, or the UE 1108 may transmit the mobility 1116 to the base station 1104. The base station may transmit a new configuration of timer range or probability range 1110 to the UE 1102 based on the mobility 1116. In some aspects, the base station 1104 may transmit the new configuration of timer range or probability range 1110 via RRC signaling. As one example, the UE 1102 may change the timer range or the probability range at 1118 after initiating a timer at 1112 and before the first timer expires (e.g., decrease to 1). In some aspects, the UE may change the timer range or the probability range as described in connection with FIGS. 8-10.

At 1120, the first timer may expire, and the UE 1102 may initiate a second timer and generate a probability. If the generated probability is within the probability range, the UE 1102 may maintain the same SPS resource. If the generated probability is outside the probability range, the UE 1102 may reselect the SPS resource based on a sidelink sensing procedure. The UE 1102 may use the reselected SPS resource or the same SPS resource to periodically transmit packets 1124 and a number of packets 1124N to the UE 1106 or the UE 1108. Upon transmitting a packet 1124 using the set of SPS resources, the UE 1102 may decrease the second timer by one. At 1126, upon expiration (e.g., decrease to 1) of the second timer, the UE may initiate a third timer and generate a probability. The probability may be randomly generated number between zero and one.

Because a UE's mobility (i.e., speed, velocity, or the like) may affect channel interference pattern, the UE's mobility may serve as a basis for determining resource reselection frequency (e.g., based on the timer range or the probability range). For example, a lower speed UE may be associated with a slow channel interference pattern, and maintaining the same periodically resource may be sufficient for the UE's transmission.

Other than a UE's mobility, battery level, or level of power-saving, the timer range or the probability range may be further based on a system channel loading congestion level, a priority of an application associated with a transmission on the selected SPS resource, a total number of resources associated with the selected SPS resource, or the like. For example, with higher system loading, the UE 1102 may be configured with a timer range with a larger maximum/minimum value or a probability range with a larger maximum value so that the UE 1102 may be more likely to maintain the selected resource. The UE 1102 may determine the system loading based on a channel busy ratio (CBR) measurement report. In some aspects, if the priority of the application associated with the transmission on the selected SPS resource is low, the UE 1102 may be configured with a timer range with a larger maximum/minimum value or a probability range with a larger maximum value so that the UE 1102 may be more likely to maintain the selected resource. In some aspects, when the total number of initially selected resources is large, the UE may be configured with a timer range with a smaller maximum/minimum value or a probability range with a smaller maximum value so that the UE 1102 may be more likely to reselect the resources. As one example, if the UE 1102 selected a large number of resources and the system channel loading is high, the UE 1102 may be configured with a smaller maximum/minimum value or a probability range with a smaller maximum value so that the UE 1102 may be more likely to reselect the resources.

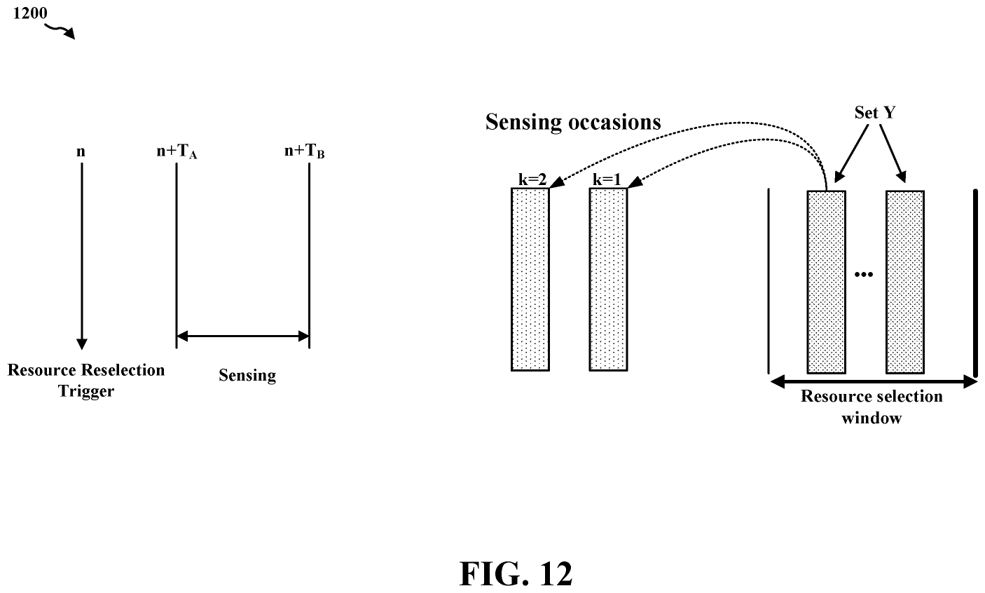

FIG. 12 is an example diagram 1200 illustrating sidelink resource selection including random selection, partial sensing, and full sensing. As illustrated in FIG. 12, random selection, partial sensing, and full sensing may be configured for the same resource set. A sensing procedure based on a sensing window may be referred to as “full sensing,” whereas a sensing procedure based on a shorter sensing window that may be a subsection of the sensing window may be referred to as “partial sensing.” “Random selection” may be used to refer to a procedure where a UE randomly selects a resource within the resource set without a sensing procedure. For example, as illustrated in FIG. 12, a UE may perform sensing between time n+T_{A} and time n+T_{B}. A partial sensing UE may configure T_{A} and T_{B} to adjust the sensing window. T_{A}and T_{B} may be positive, negative, or zero (relative to a set of candidate slots). If n+T_{A} is equal to n+T_{B}, the UE may be performing random selection. Some UEs may be configured to perform random selection in a power-saving mode and perform sensing in a normal operating mode. Some UEs, such as reduced capability UEs, may be configured to perform random selection without performing sensing.

In some aspects, for the resource set in FIG. 12 that may be configured with partial sensing, if a UE performs periodic-based partial sensing, at least when the reservation for another TB (when carried in SCI) is enabled for the resource set and resource selection/reselection is triggered at slot n, the UE may determine a set of Y candidate slots within a resource selection window. In some aspects, the UE may be subject to conditions for determining the Y candidate slots, and the conditions may be associated with discontinuous reception (DRX) that may be enabled for the UE. A UE, such as the UE 402, may be configured to monitor SCI according to one or more sidelink resource reserve periods (which may be represented in a list indicated, by way of example, by a parameter sl-ResourceReservePeriodList that may include P1 and P2). The UE may also be configured to monitor SCI based on a configurable subset indicated by a bitmap. The UE may monitor SCI in a most recent (k=1) sensing occasion or a second most recent (k=2) sensing occasion.

Because UEs that perform random selection, partial sensing, and full sensing (which may also be referred to as “random selection UEs,” “partial sensing UEs,” and “full sensing UEs”) may be configured with the same resource set, transmissions from random selection UEs may collide with transmissions from partial sensing or full sensing UEs. The collisions may cause system performance degradation. In addition, a sensing UE's transmission may be wasted because of interference from a nonsensing UE (e.g., a random selection UE) that may not be aware of the sensing UE's reservation. Some wireless communication systems may configure a separate resource set for random selection UEs in order to avoid resource collision between random selection and partial/full sensing UEs. However, such a configuration may be wasteful of resources when there may be no or few random selection UEs in an area. The separate resource set may not be able to adapt even if there is no random selection UEs in the area.

Example aspects provided herein may facilitate avoiding resource collision between random selection and partial/full sensing UEs. By configuring a random selection resource set that may be available for random selection UEs, the random selection UEs may avoid transmitting outside the random selection resource set that may collide with transmissions from partial/full sensing UEs. By configuring the random selection resource set to be also available for the sensing UEs, waste of resources may be avoided when there are no or few random selection UEs in an area.

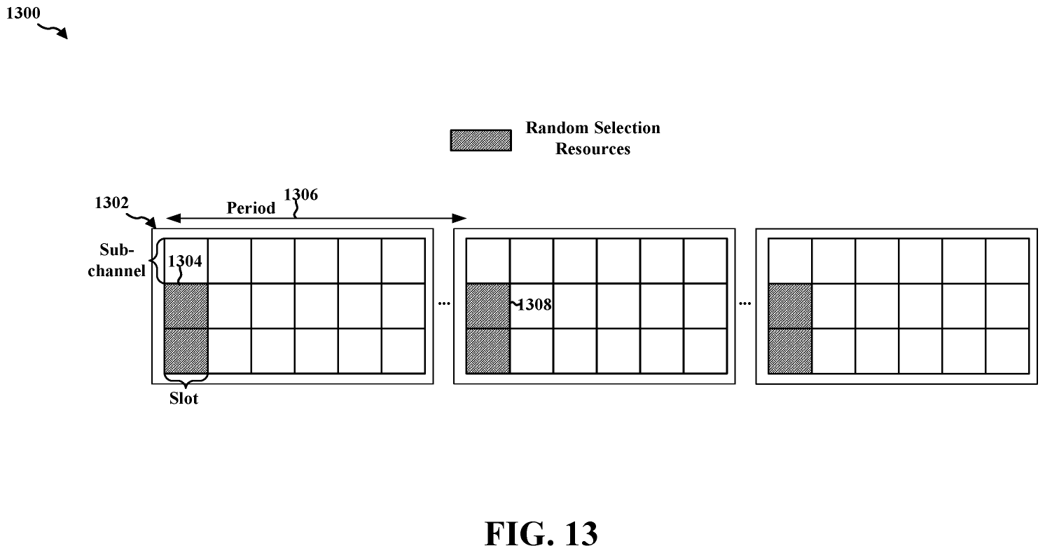

FIG. 13 is an example diagram 1300 illustrating random selection resource set and sidelink resource pool. As illustrated in FIG. 13, within a sidelink resource pool 1302 available for sensing UEs, a random selection resource set (which may be otherwise referred to as “a set of time-frequency resources,” “a set of restricted resources,” or the like) 1304 for random selection transmissions may be configured. In some aspects, the random selection resource set 1304 may be applicable to all random selection transmissions. In other words, a UE 402 may randomly select resources in the random selection resource set for random selection transmissions and may not randomly select resources outside the random selection resource set for the random selection transmissions. In some aspects, the random selection resource set 1304 may be applicable to random selection of resource for initial packets transmissions with no further restrictions on random selection of resource for retransmissions. In other words, a UE 402 may randomly select resources in the random selection resource set 1304 for initial random selection transmissions and may not randomly select resources outside the random selection resource set 1304 for the initial random selection transmissions. However, the UE 402 may randomly select resources outside the random selection resource set 1304 (and within the sidelink resource pool 1302) for subsequent retransmissions of the same packet. A sensing UE may be able to detect a reservation associated with the initial transmission.

In some aspects, the random selection resource set 1304 may be applicable to initial random selection packets transmissions for a UE 402 that may perform the random selection and on-demand or partial sensing. In some aspects, the random selection resource set 1304 may be applicable to all random selection transmissions for a UE that may not perform sensing. In some aspects, the random selection resource set may be periodically dedicated for random selection transmission with a periodicity. For example, as illustrated in FIG. 13, the random selection resource set 1304 may be associated with a period 1306, and a second random selection resource set 1308 may be dedicated for random selection after a period 1306. In some aspects, the periodicity may be (pre)configured to the UE 402 or configured by a base station in a network.

A UE may be configured with a pre-emption where the UE may signal the UE's selected resource while receiving a reservation (such as via SCI) on the same resource with a higher priority. The UE may be configured to reselect the resource because the received reservation pre-empts the UE's resource selection. In some aspects, for the UE 1102 operating with a timer range with a larger maximum/minimum value or a probability range with a larger maximum value for power-saving, pre-emption may be disabled.

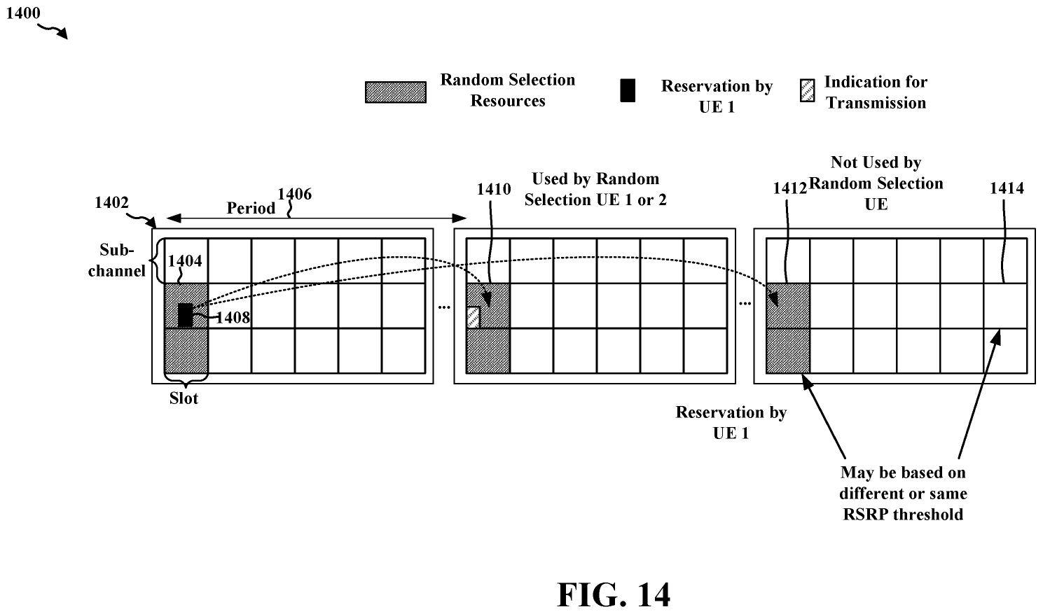

In some aspects, random selection UEs may signal in first stage SCI to reserve the periodic resource occupation. FIG. 14 is an example diagram 1400 illustrating a UE's reservation in a random selection resource set. As illustrated in FIG. 14, within a random sidelink resource pool 1402 available for sensing UEs, a random selection resource set 1404 for random selection transmissions may be configured. The random selection resource set 1404 may be associated with a period 1406, and a second random selection resource 1410 may be dedicated for random selection after a period 1406 from the random selection resource pool 1402. A third random selection resource 1412 may be configured for random selection for a time after a third period. As illustrated in FIG. 14, a UE 402 may transmit a reservation 1408 reserving the periodic resources, including resources in the second random selection resource 1410 and the third random selection resource 1412. In some aspects, the UE 402 may transmit the reservation 1408 via first stage SCI. A sensing UE may avoid using the reserved resource when the sensing UE decodes the first stage SCI. In some aspects, the UE 402 may transmit with resource at a first time, and signal in the first stage SCI, but does not transmit again with the reserved resource at a second time. For example, as illustrated in FIG. 14, the UE 402 (which may be referred to as “UE 1”) may reserve the periodic resource by transmitting the reservation 1408 but may or may not use a resource in the second random selection resource 1410. The reserved resource in the second random selection resource 1410 may be used by a second UE. In other words, a random selection UE may reserve resource on behalf of all random selection UEs. The UE may or may not transmit in the reserved resources.

In some aspects, to avoid potential resource collision among random selection UEs in the random selection resource set, an indication (which may be a one-bit indication) may be used to indicate whether the reserved resource at time is used by the random selection UE. For example, as illustrated in FIG. 14, the UE 402 or another UE that uses the reserved resource in the second random selection resource 1410 may transmit an indication. By transmitting an indication, other random selection UEs that may perform on-demand sensing may avoid using the resource after one periodicity ( ).

In some aspects, a sensing UE may also be able to detect the indication. In some aspects, based on a lack of indication of transmission from a random selection UE, a sensing UE may be able to transmit in the reserved resources, making resource usage within the system more efficient. For example, as illustrated in FIG. 14, a sensing UE may perform sensing within the sidelink resource pool. Based on the sensing (which may be based on a lack of indication of transmission from a random selection UE or based on an RSRP threshold) within the set, the sensing UE may select a resource within the third random selection resource 1412 or a resource 1414 outside the third random selection resource 1412. The sensing UE may use the same or different RSRP thresholds for resources within the third random selection resource 1412 and resources outside the third random selection resource 1412.

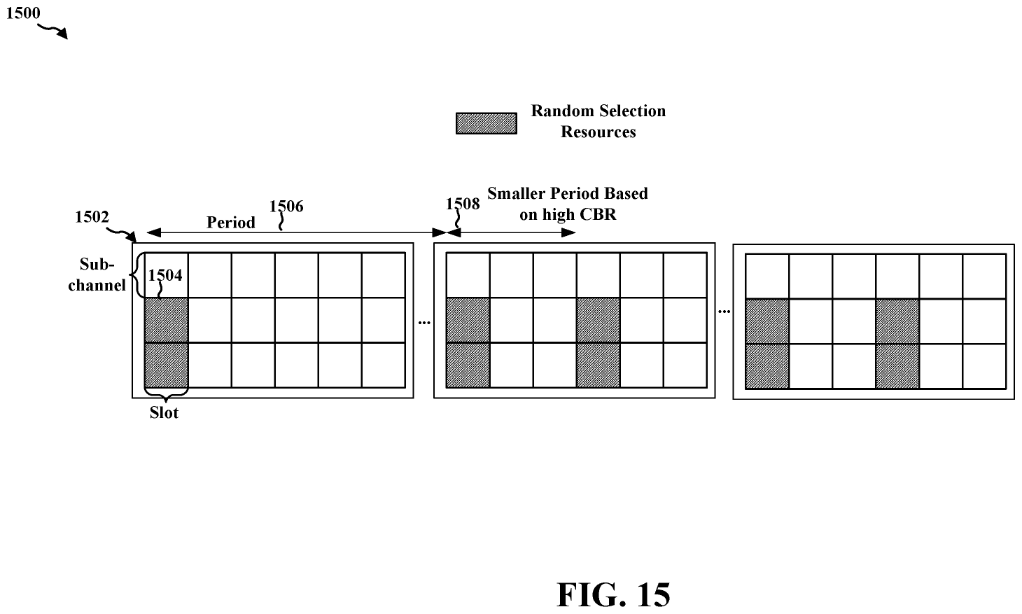

In some aspects, the size of the random selection resource set (which may be based on the period and the number of resources within a period) may be dynamically configured. For example, a base station may configure a small number of resources within the random selection resource set, then the base station or a UE may adapt the number of resources within the random selection resource set when there are more random selection UEs. In another example, one or more UEs may exchange measurements, such as a channel busy ratio (CBR) within the random selection resource set, and determine a periodicity. The one or more UEs may determine the periodicity based on a voting mechanism. In some aspects, one or more sensing UEs may perform CBR measurements, determine a periodicity and transmit the determined periodicity to the one or more random selection UEs. In another example, a random selection UE may receive a sequence to receive the periodicity. For example, a cyclic shift associated with the sequence may be indicating a periodicity, and different cyclic shifts may be indicating different periodicity. In some aspects, a random selection UE may receive more than one periodicity. Among the more than one periodicities, the random selection UE may pick a periodicity transmitted in a resource with a largest RSRP or the largest periodicity. In another example, based on the CBR, a UE or a base station may increase the number of resources within the random selection resource set by decreasing the period or by expanding the number of resources within each period. In one example, a UE may detect that a CBR within the random selection resource set may be higher than a CBR threshold and set a smaller period based on the CBR being higher than the CBR threshold. In some aspects, the sensing UEs may know the status of the random selection resource set by checking a range (e.g., the smallest value) signaled by all random selection UEs. When a random selection UE supports discontinuous reception (DRX), the random selection UE may tune the DRX cycle to multiple times to maximize power saving random. FIG. 15 is an example diagram 1500 illustrating the adjustment of a period associated with a random selection resource set. As illustrated in FIG. 15, within a sidelink resource pool 1502 available for sensing UEs, a random selection resource set 1504 for random selection transmissions may be configured. The random selection resource set 1504 may be associated with a period 1506. Based on a high CBR or a high number of random selection UEs within an area, the period 1506 may be changed (by a base station or a UE) to a smaller period 1508. Therefore, within a timeframe, the amount of resources in a random selection resource set may be increased.

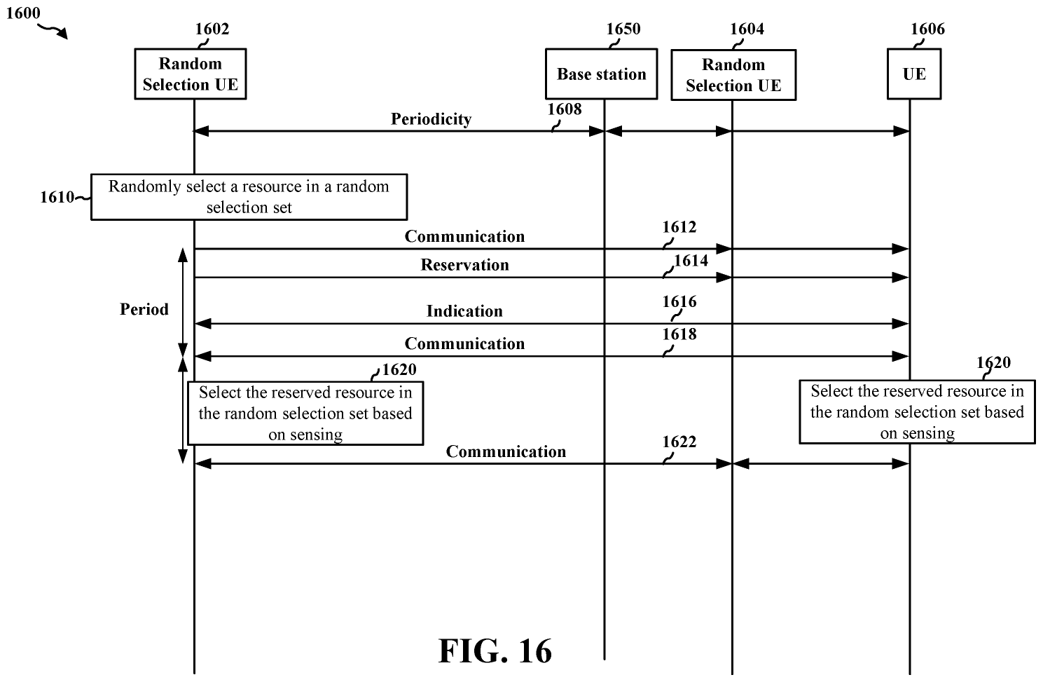

FIG. 16 is a communication flow 1600 between a base station 1650 and UEs that may perform the random selection and sensing, including a random selection UE 1602, a random selection UE 1604, and a sensing UE 1606. The random selection UE 1602 and the random selection UE 1604 may be able to perform partial sensing. As illustrated in FIG. 16, the base station 1650, a sensing UE, a random selection UE, or one or more UEs (e.g., as previously described with the CBR measurements and the voting mechanism) may transmit a periodicity of a random selection resource set to each UEs in the area, including the random selection UE 1602, the random selection UE 1604, and the sensing UE 1606. At 1610, the UE 1602 may randomly select a resource in the random selection set. The UE 1602 may transmit a communication 1612 based on the select resource. In some aspects, the UE 1602 may transmit a reservation 1614 reserving a set of periodic resources, which includes the resource, e.g., as described in connection with FIG. 9. Another random selection UE may use the reserved resource. For example, the random selection UE 1604 may transmit a communication 1618 in the reserved resource. In some aspects, prior to transmitting the communication 1618, the random selection UE 1604 may transmit an indication 1616 to indicate that the random selection UE 1604 will use the reserved resource. In some aspects, based on a lack of indication, a sensing UE, such as the sensing UE 1606 or the random selection UE 1602 that may perform on-demand sensing, may select the reserved based on sensing at 1620 and may accordingly transmit a communication 1622.

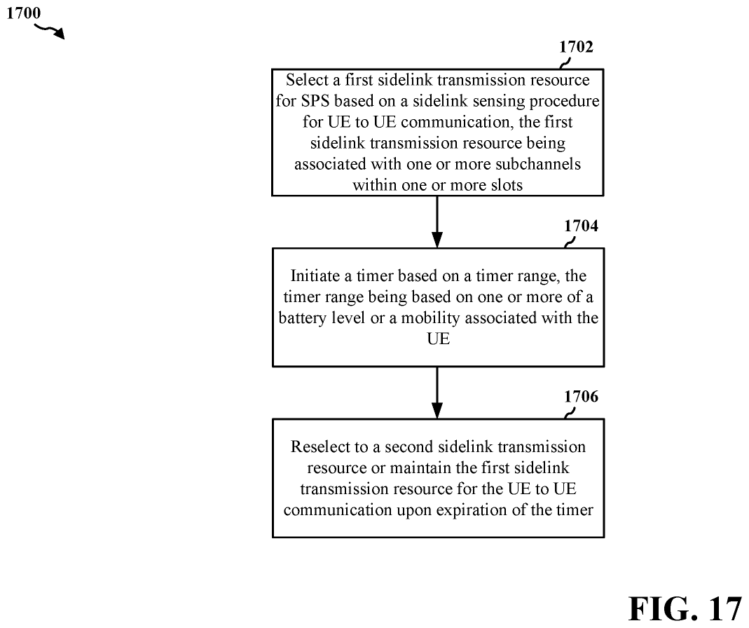

FIG. 17 is a flowchart 1700 of a method of wireless communication. The method may be performed by a UE (e.g., the UE 104, the UE 402, the UE 1102, or other UEs; the apparatus 1902). The method may be used for power-saving for a sidelink UE with SPS transmissions.

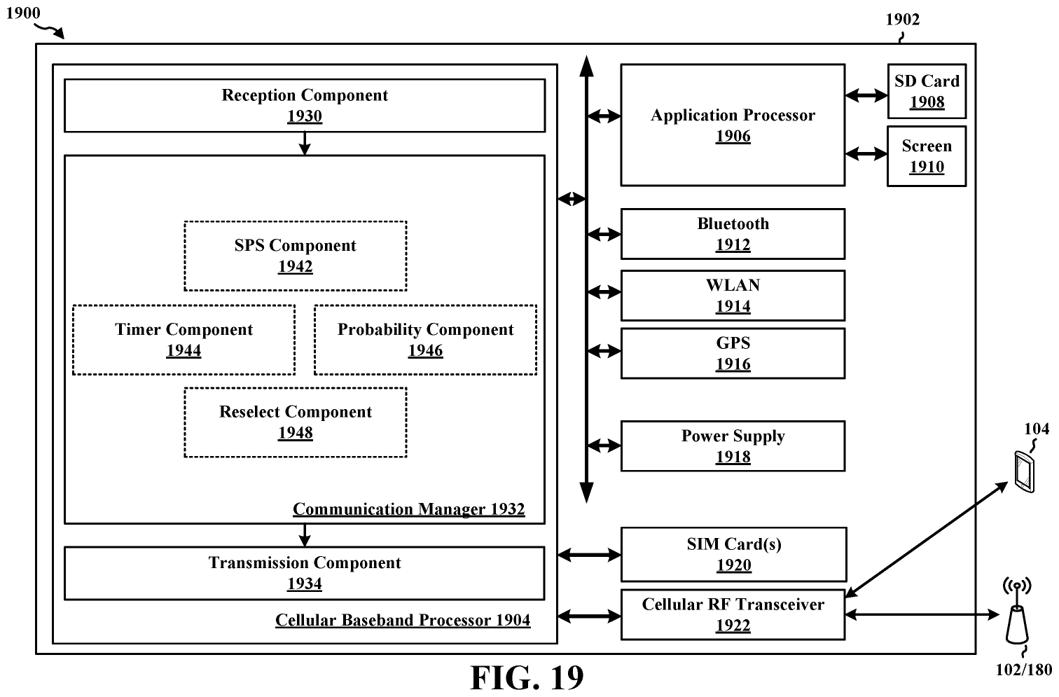

At 1702, the UE may select a first sidelink transmission resource for SPS based on a sidelink sensing procedure for UE-to-UE communication. The first sidelink transmission resource may be associated with one or more subchannels within one or more slots. For example, the UE 1102 may select a first sidelink transmission resource for SPS based on a sidelink sensing procedure for UE-to-UE communication. The first sidelink transmission resource may be associated with one or more subchannels within one or more slots at 1112. As one example, a UE 402 may select a first sidelink transmission resource, including the resource 910A and the resource 910B. In some aspects, 1702 may be performed by the SPS component 1942 of FIG. 19.

At 1704, the UE may initiate a timer based on a timer range. The timer range may be based on one or more of a battery level or a mobility associated with the UE. For example, at 1112, the UE 1102 may initiate a timer based on a timer range. The timer range may be based on one or more of a battery level or a mobility associated with the UE. As one example, as illustrated in FIG. 9, a UE 402 may initiate a timer with a value of 103 based on a timer range of [50 150] based on the UE 402's battery level, mobility, or the like. In some aspects, 1704 may be performed by the timer component 1944 of FIG. 19.

At 1706, the UE may reselect a second sidelink transmission resource or maintain the first sidelink transmission resource for the UE-to-UE communication upon expiration of the timer. For example, at 1120, the UE 1102 may reselect a second sidelink transmission resource or maintain the first sidelink transmission resource for the UE-to-UE communication upon expiration of the timer. As one example, as illustrated in FIGS. 9-10, a UE 402 may reselect a second sidelink transmission resource including resource 916A and resource 916B or maintain the first sidelink transmission resource including resource 1016A and resource 1016B. In some aspects, 1706 may be performed by the reselect component 1948 of FIG. 19.

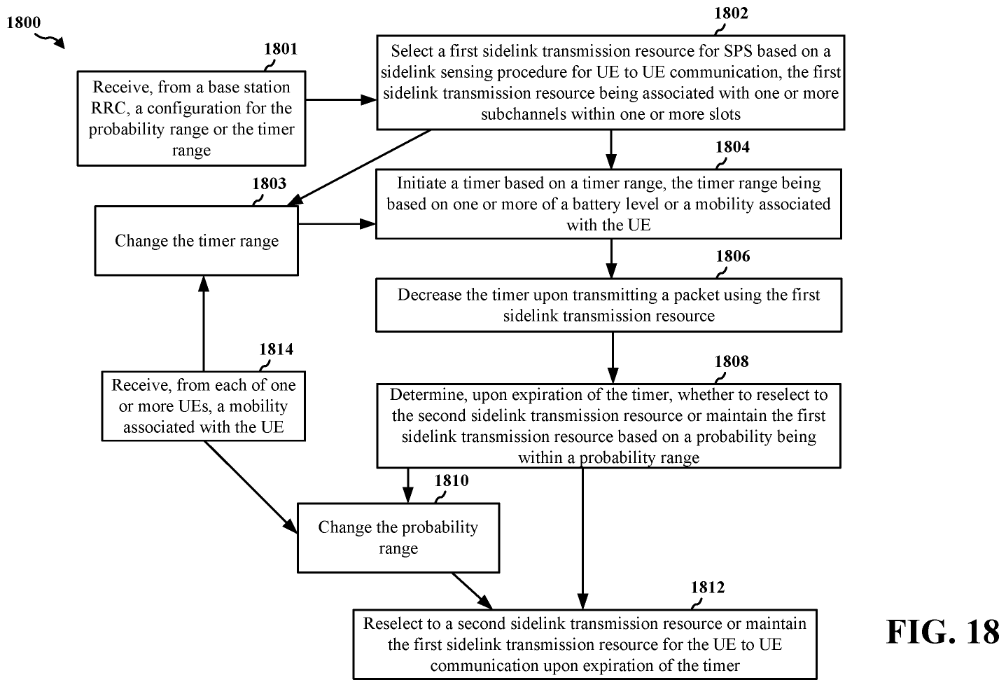

FIG. 18 is a flowchart 1800 of a method of wireless communication. The method may be performed by a UE (e.g., the UE 104, the UE 402, the UE 1102, or other UEs; the apparatus 1902). The method may be used for power-saving for a sidelink UE with SPS transmissions.

In some aspects, at 1801, the UE may receive, from a base station via RRC, a configuration for the probability range or the timer range. For example, the UE 1102 may receive configuration of timer range or probability range 1110 from the base station 1104 via RRC. In some aspects, 1801 may be performed by the reception component 1930 of FIG. 19.

At 1802, the UE may select a first sidelink transmission resource for SPS based on a sidelink sensing procedure for UE-to-UE communication. The first sidelink transmission resource may be associated with one or more subchannels within one or more slots. For example, the UE 1102 may select a first sidelink transmission resource for SPS based on a sidelink sensing procedure for UE-to-UE communication. The first sidelink transmission resource may be associated with one or more subchannels within one or more slots at 1112. As one example, a UE 402 may select a first sidelink transmission resource, including the resource 910A and the resource 910B. In some aspects, 1802 may be performed by the SPS component 1942 of FIG. 19. In some aspects, an SCI-based pre-emption associated with the first sidelink transmission resource or the second sidelink transmission resource is disabled for the UE.

At 1804, the UE may initiate a timer based on a timer range. The timer range may be based on one or more of a battery level or a mobility associated with the UE. For example, at 1112, the UE 1102 may initiate a timer based on a timer range. The timer range may be based on one or more of a battery level or a mobility associated with the UE. As one example, as illustrated in FIG. 9, a UE 402 may initiate a timer with a value of 103 based on a timer range of [50 150] based on the UE 402's battery level, mobility, or the like. In some aspects, 1804 may be performed by the timer component 1944 of FIG. 19.

In some aspects, the timer range may be associated with a maximum value and a minimum value, the maximum value or the minimum value may be negatively correlated (which may be otherwise referred to as “inversely correlated”) with at least one of the mobility or the battery level associated with the UE. In some aspects, “negatively correlated” may refer to a relationship between two variables in which one variable increases as the other decreases, and vice versa. For example, if speed or velocity decreases, the the maximum value or the minimum value may increase. In another example, if battery level decreases, the the maximum value or the minimum value may increase. In some aspects, at 1803, the UE may be configured to change the timer range, such as by changing the minimum value or the maximum value based on the mobility being less than a mobility threshold or the battery level being less than a battery threshold. For example, as illustrated in FIG. 9, In some aspects, 1803 may be performed by the timer component 1944 of FIG. 19.

In some aspects, at 1806, the UE may decrease the timer upon transmitting a packet using the first sidelink transmission resource. For example, as illustrated in FIG. 11, the UE 1102 may decrease the timer upon transmitting a packet (such as the packet 1114) using the first sidelink transmission resource. In some aspects, 1806 may be performed by the timer component 1944 of FIG. 19.

In some aspects, at 1814, the UE may receive, from each of one or more UEs, an indication of a mobility associated with the UE (e.g., each of the one or more UEs). In some aspects, 1814 may be performed by the reception component 1930 of FIG. 19. In some aspects, the timer range may be further based on the mobility for each of the one or more UEs. In some aspects, the timer range may be associated with a maximum value and a minimum value, the maximum value or the minimum value may be negatively correlated with the one or more mobility associated with the one or more UEs. For example, as illustrated in FIG. 9, the mobility associated with the UE 406 and the UE 404 may be negatively correlated with a maximum/minimum value of the timer range. For example, if the UE 406 or the UE 404 is moving fast, the timer range may be associated with a smaller maximum/minimum value.

In some aspects, at 1808, the UE may determine, upon expiration of the timer, whether to reselect the second sidelink transmission resource or maintain the first sidelink transmission resource based on a probability being within a probability range. In some aspects, the probability may be randomly generated number between zero and one. For example, the UE 1102 may determine, upon expiration of the timer, whether to reselect the second sidelink transmission resource or maintain the first sidelink transmission resource based on a probability being within a probability range at 1120. In some aspects, 1808 may be performed by the reselect component 1948 of FIG. 19. In some aspects, the probability range may be further based on the received indication of the mobility for each of the one or more UEs (received at 1803). For example, as illustrated in FIG. 9, the mobility associated with the UE 406 and the UE 404 may be negatively correlated with a maximum value of the probability range. For example, if the UE 406 or the UE 404 is moving fast, the probability range may be associated with a smaller maximum value. In some aspects, a maximum value associated with the probability range is negatively correlated with at least one of the mobility or the battery level associated with the UE.

In some aspects, at 1810, the UE may change the maximum value based on the mobility being less than a mobility threshold or the battery level being less than a battery threshold. For example, as illustrated in FIG. 9, the UE 402 may increase the maximum value from 0.8 to 0.95 based on a low battery level or low mobility (e.g., UE 402 not moving at a speed/velocity higher than a threshold). In some aspects, 1810 may be performed by the probability component 1946 of FIG. 19. In some aspects, the timer range or the probability range may be further based on one or more of: a system channel loading congestion level, a total number of resources associated with the first sidelink transmission resource, or a priority of the UE-to-UE communication. For example, a maximum value associated with the probability range may be positively correlated with the system channel loading congestion level. In another example, the timer range may be associated with a maximum value and a minimum value. The maximum value or the minimum value may be negatively correlated with the total number of resources. In some aspects, a maximum value associated with the probability range may be negatively correlated with the total number of resources.

At 1812, the UE may reselect a second sidelink transmission resource or maintain the first sidelink transmission resource for the UE-to-UE communication upon expiration of the timer. For example, at 1120, the UE 1102 may reselect a second sidelink transmission resource or maintain the first sidelink transmission resource for the UE-to-UE communication upon expiration of the timer. As one example, as illustrated in FIGS. 9-10, a UE 402 may reselect a second sidelink transmission resource including resource 916A and resource 916B or maintain the first sidelink transmission resource including resource 1016A and resource 1016B. In some aspects, 1812 may be performed by the reselect component 1948 of FIG. 19.

FIG. 19 is a diagram 1900 illustrating an example of a hardware implementation for an apparatus 1902. The apparatus 1902 may be a UE, a component of a UE, or may implement UE functionality. In some aspects, the apparatus 1902 may include a cellular baseband processor 1904 (also referred to as a modem) coupled to a cellular RF transceiver 1922. In some aspects, the apparatus 1902 may further include one or more subscriber identity modules (SIM) cards 1920, an application processor 1906 coupled to a secure digital (SD) card 1908 and a screen 1910, a Bluetooth module 1912, a wireless local area network (WLAN) module 1914, a Global Positioning System (GPS) module 1916, or a power supply 1918. The cellular baseband processor 1904 communicates through the cellular RF transceiver 1922 with the UE 104 and/or BS 102/180. The cellular baseband processor 1904 may include a computer-readable medium/memory. The computer-readable medium/memory may be non-transitory. The cellular baseband processor 1904 is responsible for general processing, including the execution of software stored on the computer-readable medium/memory. The software, when executed by the cellular baseband processor 1904, causes the cellular baseband processor 1904 to perform the various functions described supra. The computer-readable medium/memory may also be used for storing data that is manipulated by the cellular baseband processor 1904 when executing software. The cellular baseband processor 1904 further includes a reception component 1930, a communication manager 1932, and a transmission component 1934. In some aspects, the reception component 1930 may be configured to receive, from a base station RRC, a configuration for the probability range or the timer range and receive, from each of one or more UEs, an indication of a mobility associated with the UE, e.g., as illustrated in connection with 1801 and 1814. The communication manager 1932 includes the one or more illustrated components. The components within the communication manager 1932 may be stored in the computer-readable medium/memory and/or configured as hardware within the cellular baseband processor 1904. The cellular baseband processor 1904 may be a component of the UE 350 and may include the memory 360 and/or at least one of the TX processor 368, the RX processor 356, and the controller/processor 359. In one configuration, the apparatus 1902 may be a modem chip and include just the cellular baseband processor 1904, and in another configuration, the apparatus 1902 may be the entire UE (e.g., sec 350 of FIG. 3) and include the additional modules of the apparatus 1902.

The communication manager 1932 may include an SPS component 1942 that may be configured to select a first sidelink transmission resource for SPS based on a sidelink sensing procedure for UE-to-UE communication, e.g., as described in connection with 1702 of FIG. 17, or 1802 of FIG. 18. The communication manager 1932 may further include a timer component 1944 that may be configured to initiate a timer based on a timer range, decrease the timer upon transmitting a packet using the first sidelink transmission resource, or change the timer, e.g., as described in connection with 1704 of FIG. 17, or 1803, 1804, or 1806 of FIG. 18. The communication manager 1932 may further include a probability component 1946 that may be configured to change the maximum value associated with a probability range, e.g., as described in connection with 1810 of FIG. 18. The communication manager 1932 may further include a reselect component 1948 that may be configured to determine, upon expiration of the timer, whether to reselect the second sidelink transmission resource or maintain the first sidelink transmission resource based on a probability being within a probability range and reselect a second sidelink transmission resource or maintain the first sidelink transmission resource for the UE-to-UE communication upon expiration of the timer, e.g., as described in connection with 1706 of FIG. 17, or 1812 of FIG. 18.

The apparatus may include additional components that perform each of the blocks of the algorithm in the flowcharts of FIGS. 17-18. As such, each block in the flowcharts of FIGS. 17-18 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1902 may include a variety of components configured for various functions. In one configuration, the apparatus 1902, and in particular the cellular baseband processor 1904, may include means for selecting a first sidelink transmission resource for SPS based on a sidelink sensing procedure for UE-to-UE communication. The cellular baseband processor 1904 may further include means for initiating a timer based on a timer range. The cellular baseband processor 1904 may further include means for reselecting a second sidelink transmission resource or maintain the first sidelink transmission resource for the UE-to-UE communication upon expiration of the timer. The cellular baseband processor 1904 may further include means for changing the minimum value or the maximum value based on the mobility being less than a mobility threshold or the battery level being less than a battery threshold. The cellular baseband processor 1904 may further include means for decreasing the timer upon transmitting a packet using the first sidelink transmission resource. The cellular baseband processor 1904 may further include means for receiving, from each of one or more UEs, an indication of a mobility associated with the UE. The cellular baseband processor 1904 may further include means for determining, upon expiration of the timer, whether to reselect the second sidelink transmission resource or maintain the first sidelink transmission resource based on a probability being within a probability range. The cellular baseband processor 1904 may further include means for receiving, from each of one or more UEs, an indication of a mobility associated with the UE. The cellular baseband processor 1904 may further include means for changing the maximum value based on the mobility being less than a mobility threshold or the battery level being less than a battery threshold. The cellular baseband processor 1904 may further include means for changing the maximum value to be greater than 0.8. The cellular baseband processor 1904 may further include means for receiving, from a base station via RRC, a configuration for the probability range or the timer range. The means may be one or more of the components of the apparatus 1902 configured to perform the functions recited by the means. As described supra, the apparatus 1902 may include the TX Processor 368, the RX Processor 356, and the controller/processor 359. As such, in one configuration, the means may be the TX Processor 368, the RX Processor 356, and the controller/processor 359 configured to perform the functions recited by the means.

Example aspects provided herein may be used by a sidelink UE for saving power. The UE may save power by reducing the number of sensing occasions where an SPS resource reselection is triggered. In some aspects, the UE may be able to save power by triggering the SPS resource reselection less frequently based on a battery level of the UE, mobility of the UE, mobility of other UEs, or the like. By triggering SPS resource reselection less frequently, the UE may reduce the number of power-consuming sensing. In some aspects, the UE may be able to trigger an SPS resource reselection less frequently by increasing the time between SPS resource reselection triggers. In some aspects, the UE may be able to trigger an SPS resource reselection less frequently by decreasing the probability of activating an SPS resource reselection trigger.

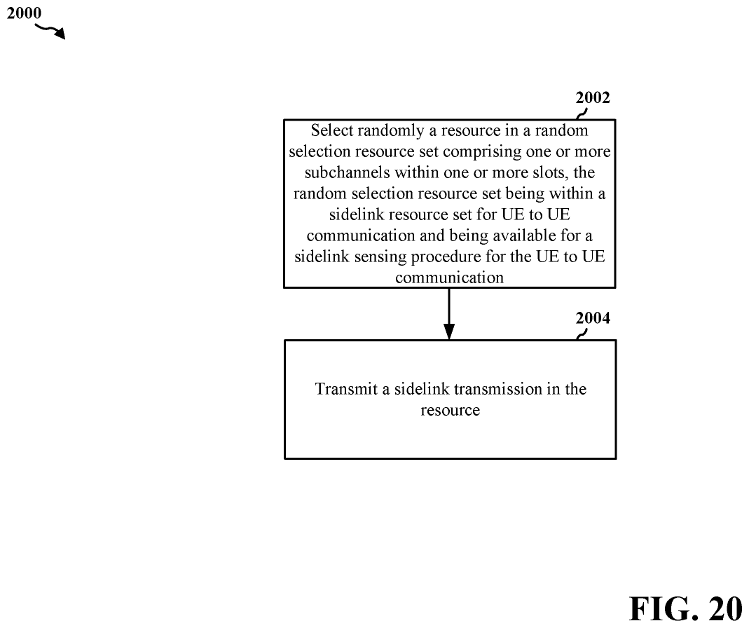

FIG. 20 is a flowchart 2000 of a method of wireless communication. The method may be performed by a UE (e.g., the UE 104, the UE 402, the UE 1602, the UE 1604, or other UEs; the apparatus 2202).

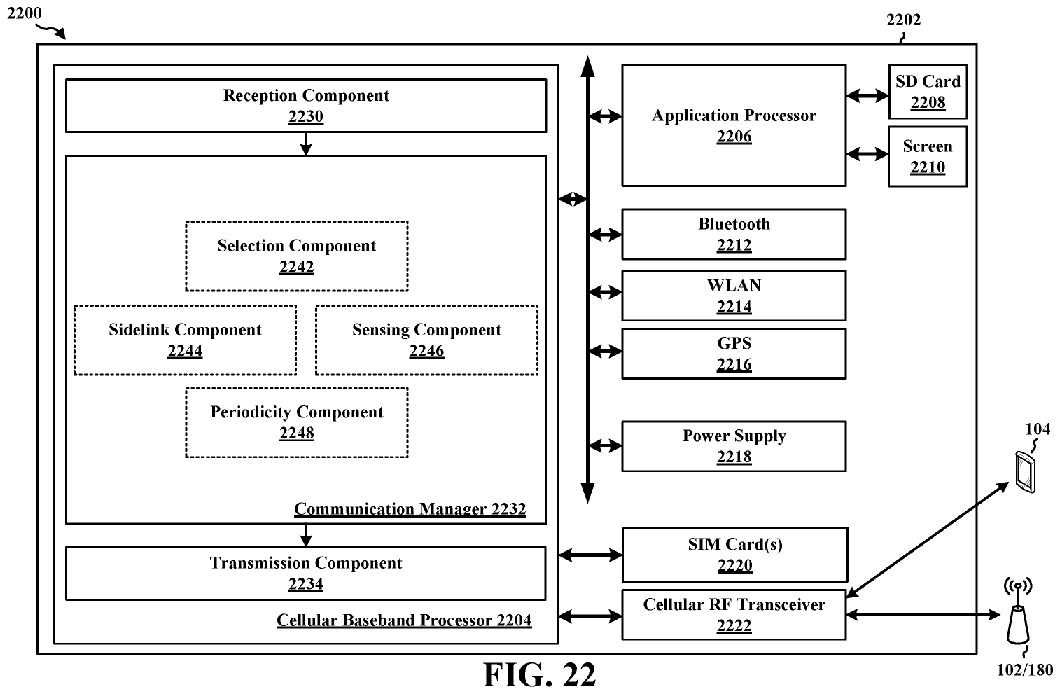

At 2002, the UE may select randomly a resource in a random selection resource set including one or more subchannels within one or more slots. The random selection resource set may be within a sidelink resource pool for UE-to-UE communication and may be available for a sidelink sensing procedure for the UE-to-UE communication. For example, the UE 1602 may select randomly, at 1610, a resource in a random selection resource set including one or more subchannels within one or more slots. The random selection resource set may be within a sidelink resource pool for UE-to-UE communication and may be available for a sidelink sensing procedure for the UE-to-UE communication. As one example, a UE 402 may select randomly a resource in a random selection resource set 1304. The random selection resource set 1304 may be within a sidelink resource pool 1302 for UE-to-UE communication and may be available for a sidelink sensing procedure for the UE-to-UE communication. In some aspects, 2002 may be performed by the selection component 2242 of FIG. 22.

At 2004, the UE may transmit a sidelink transmission in the resource. For example, the UE 1602 may transmit a sidelink transmission (e.g., the communication 1612) in the resource. In some aspects, 2004 may be performed by the sidelink component 2244 of FIG. 22.

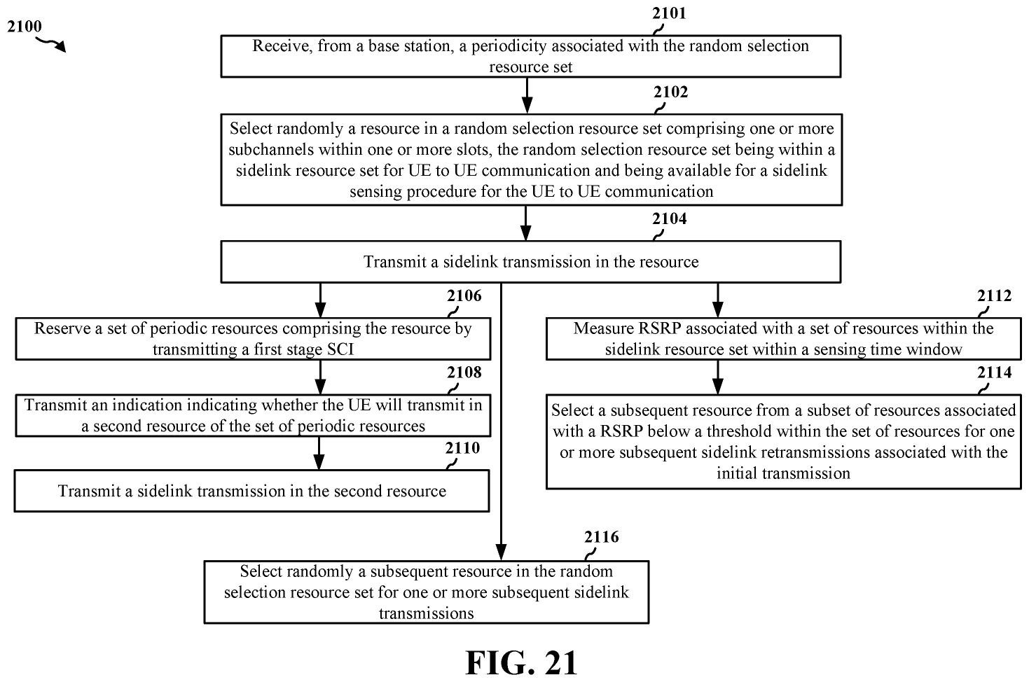

FIG. 21 is a flowchart 2100 of a method of wireless communication. The method may be performed by a UE (e.g., the UE 104, the UE 402, the UE 1602, the UE 1604, or other UEs; the apparatus 2202).

In some aspects, at 2101, the UE may receive, from a base station, a periodicity associated with the random selection resource set. For example, the UE 1602 may receive from a base station 1650, a periodicity 1608 associated with the random selection resource set. In some aspects, 2101 may be performed by the periodicity component 2248 of FIG. 22.

At 2102, the UE may select randomly a resource in a random selection resource set including one or more subchannels within one or more slots. The random selection resource set may be within a sidelink resource pool for UE-to-UE communication and may be available for a sidelink sensing procedure for the UE-to-UE communication. For example, the UE 1602 may select randomly, at 1610, a resource in a random selection resource set including one or more subchannels within one or more slots. The random selection resource set may be within a sidelink resource pool for UE-to-UE communication and may be available for a sidelink sensing procedure for the UE-to-UE communication. As one example, a UE 402 may select randomly a resource in a random selection resource set 1304. The random selection resource set 1304 may be within a sidelink resource pool 1302 for UE-to-UE communication and may be available for a sidelink sensing procedure for the UE-to-UE communication. In some aspects, 2102 may be performed by the selection component 2242 of FIG. 22.

At 2104, the UE may transmit a sidelink transmission in the resource. For example, the UE 1602 may transmit a sidelink transmission (e.g., the communication 1612) in the resource. In some aspects, 2104 may be performed by the sidelink component 2244 of FIG. 22.

In some aspects, the random selection resource set is periodic and may be associated with a periodicity. In some aspects, at 2106, the UE may reserve a set of periodic resources including the resource by transmitting a first stage SCI. For example, the UE 402 may reserve a set of periodic resources including the resource in 904, the resource in 910, and the resource in 912. In some aspects, 2106 may be performed by the sidelink component 2244 of FIG. 22. In some aspects, the periodicity associated with the random selection resource set may be negatively correlated with a total number of random selection UEs within an area or a CBR associated with the random selection resource set. In some aspects, a number of resources associated with the random selection resource set may be positively correlated with a total number of random selection UEs within an area or a CBR associated with the random selection resource set. For example, as illustrated in FIG. 10, the period 1506 may be changed to a smaller period 1508 based on a CBR or a total number of random selection UEs within an area.

In some aspects, at 2108, the UE may transmit an indication indicating whether the UE will transmit in a second resource of the set of periodic resources. For example, the UE 402 may transmit an indication indicating whether the UE will transmit in a second resource in 910 of the set of periodic resources. In some aspects, 2108 may be performed by the sidelink component 2244 of FIG. 22.

In some aspects, at 2110, the UE may transmit a sidelink transmission in the second resource. For example, the UE 402 may transmit a sidelink transmission in the second resource in 910. In some aspects, 2110 may be performed by the sidelink component 2244 of FIG. 22.

In some aspects, the sidelink transmission at 2104 may be an initial transmission, and the UE may measure, at 2112, RSRP associated with a set of resources within the sidelink resource pool within a sensing time window. For example, the UE 1602 may perform sensing and measure RSRP associated with a set of resources at 1620. In some aspects, 2112 may be performed by the sensing component 2246 of FIG. 22.

In some aspects, at 2114, the UE may select a subsequent resource from a subset of resources associated with an RSRP below a threshold within the set of resources for one or more subsequent sidelink retransmissions associated with the initial transmission. For example, the UE 1602 may perform sensing and select a subsequent resource from a subset of resources associated with an RSRP below a threshold within the set of resources for one or more subsequent sidelink retransmissions (e.g., communication 1622) associated with the initial transmission.

In some aspects, at 2116, the UE may select randomly a subsequent resource in the random selection resource set for one or more subsequent sidelink transmissions. For example, the UE 402 may select randomly a subsequent resource in the random selection resource set 808 for one or more subsequent sidelink transmissions. In some aspects, 2116 may be performed by the selection component 2242 of FIG. 22. In some aspects, the sidelink transmission may be an initial transmission, and the UE may select randomly, at 2116, a subsequent resource in the random selection resource set for one or more subsequent sidelink transmissions associated with the initial transmission.

FIG. 22 is a diagram 2200 illustrating an example of a hardware implementation for an apparatus 2202. The apparatus 2202 may be a UE, a component of a UE, or may implement UE functionality. In some aspects, the apparatus 2202 may include a cellular baseband processor 2204 (also referred to as a modem) coupled to a cellular RF transceiver 2222. In some aspects, the apparatus 2202 may further include one or more subscriber identity modules (SIM) cards 2220, an application processor 2206 coupled to a secure digital (SD) card 2208 and a screen 2210, a Bluetooth module 2212, a wireless local area network (WLAN) module 2214, a Global Positioning System (GPS) module 2216, or a power supply 2218. The cellular baseband processor 2204 communicates through the cellular RF transceiver 2222 with the UE 104 and/or BS 102/180. The cellular baseband processor 2204 may include a computer-readable medium/memory. The computer-readable medium/memory may be non-transitory. The cellular baseband processor 2204 is responsible for general processing, including the execution of software stored on the computer-readable medium/memory. The software, when executed by the cellular baseband processor 2204, causes the cellular baseband processor 2204 to perform the various functions described supra. The computer-readable medium/memory may also be used for storing data that is manipulated by the cellular baseband processor 2204 when executing software. The cellular baseband processor 2204 further includes a reception component 2230, a communication manager 2232, and a transmission component 2234. In some aspects, the reception component 2230 may be configured to receive, from a base station RRC, a configuration for the probability range or the timer range and receive, from each of one or more UEs, an indication of a mobility associated with the UE, e.g., as illustrated in connection with 2101 and 2114. The communication manager 2232 includes the one or more illustrated components. The components within the communication manager 2232 may be stored in the computer-readable medium/memory and/or configured as hardware within the cellular baseband processor 2204. The cellular baseband processor 2204 may be a component of the UE 350 and may include the memory 360 and/or at least one of the TX processor 368, the RX processor 356, and the controller/processor 359. In one configuration, the apparatus 2202 may be a modem chip and include just the cellular baseband processor 2204, and in another configuration, the apparatus 2202 may be the entire UE (e.g., sec 350 of FIG. 3) and include the additional modules of the apparatus 2202.

The communication manager 2232 may include a selection component 2242 that is configured to select randomly a resource in a random selection resource set including one or more subchannels within one or more slots or select randomly a subsequent resource in the random selection resource set for one or more subsequent sidelink transmissions, e.g., as described in connection with 2002 of FIG. 20, 2102 of FIG. 21, or 2116 of FIG. 21. The communication manager 2232 may further include a sidelink component 2244 that may be configured to transmit a sidelink transmission, reserve a set of periodic resources including the resource by transmitting a first stage SCI, or transmit an indication indicating whether the UE will transmit in a second resource of the set of periodic resources, e.g., as described in connection with 2004 of FIG. 20, 2104 of FIG. 21, 2106 of FIG. 21, 2108 of FIG. 21, or 2110 of FIG. 21. The communication manager 2232 may further include a sensing component 2246 that may be configured to measure RSRP associated with a set of resources within the sidelink resource pool within a sensing time window and select a subsequent resource from a subset of resources associated with an RSRP below a threshold within the set of resources for one or more subsequent sidelink retransmissions associated with the initial transmission, e.g., as described in connection with 2112 of FIG. 21, or 2114 of FIG. 21. The communication manager 2232 may further include a periodicity component 2248 that may be configured to receive, from a base station, a periodicity associated with the random selection resource set, e.g., as described in connection with 2101 of FIG. 21.

The apparatus may include additional components that perform each of the blocks of the algorithm in the flowcharts of FIGS. 20-21. As such, each block in the flowcharts of FIGS. 20-21 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2202 may include a variety of components configured for various functions. In one configuration, the apparatus 2202, and in particular the cellular baseband processor 2204, may include means for selecting randomly a resource in a random selection resource set including one or more subchannels within one or more slots. The random selection resource set may be within a sidelink resource pool for UE-to-UE communication and may be available for a sidelink sensing procedure for the UE-to-UE communication. The cellular baseband processor 2204 may further include means for transmitting a sidelink transmission in the resource. The cellular baseband processor 2204 may further include means for selecting randomly a subsequent resource in the random selection resource set for one or more subsequent sidelink transmissions. The cellular baseband processor 2204 may further include means for selecting randomly a subsequent resource in the sidelink resource pool for one or more subsequent sidelink retransmissions associated with the initial transmission. The cellular baseband processor 2204 may further include means for measuring RSRP associated with a set of resources within the sidelink resource pool within a sensing time window. The cellular baseband processor 2204 may further include means for selecting a subsequent resource from a subset of resources associated with an RSRP below a threshold within the set of resources for one or more subsequent sidelink retransmissions associated with the initial transmission. The cellular baseband processor 2204 may further include means for reserving a set of periodic resources including the resource by transmitting a first stage SCI. The cellular baseband processor 2204 may further include means for transmitting an indication indicating whether the UE will transmit in a second resource of the set of periodic resources. The cellular baseband processor 2204 may further include means for receiving, from a base station, a periodicity associated with the random selection resource set. The means may be one or more of the components of the apparatus 2202 configured to perform the functions recited by the means. As described supra, the apparatus 2202 may include the TX Processor 368, the RX Processor 356, and the controller/processor 359. As such, in one configuration, the means may be the TX Processor 368, the RX Processor 356, and the controller/processor 359 configured to perform the functions recited by the means.

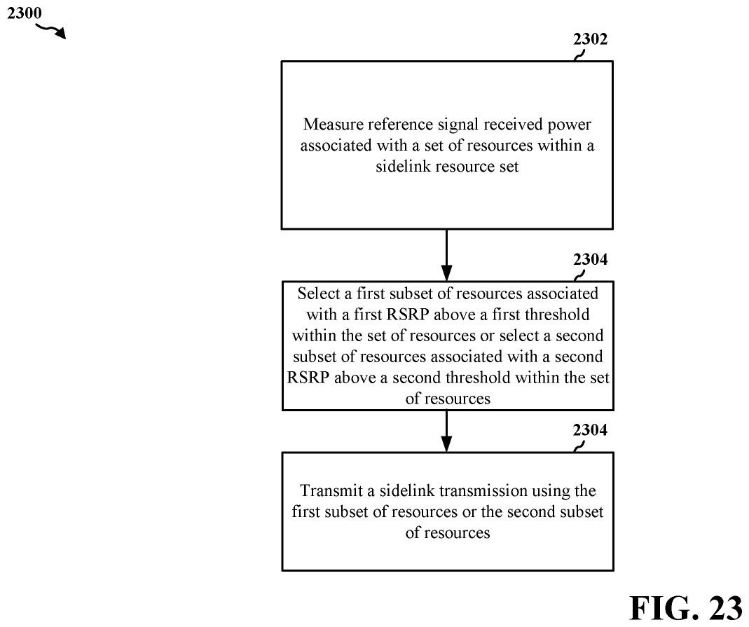

FIG. 23 is a flowchart 2300 of a method of wireless communication. The method may be performed by a UE (e.g., the UE 104, the UE 402, the UE 1606, or other UEs; the apparatus 2402).

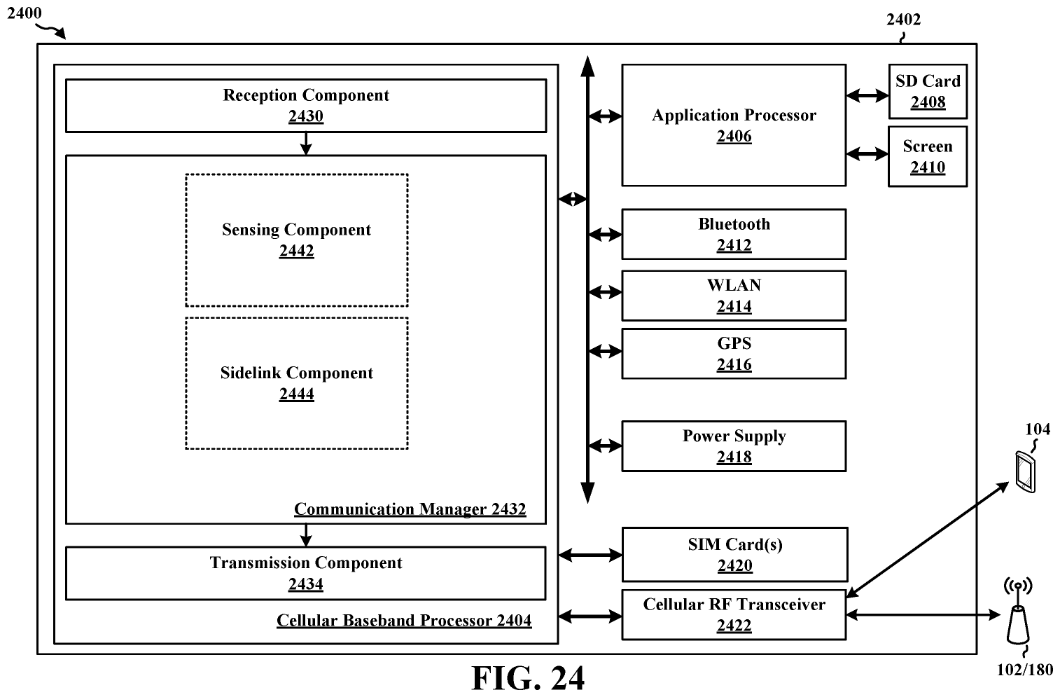

At 2302, the UE may measure RSRP associated with a set of resources within a sidelink resource pool. For example, the UE 402 may measure RSRP associated with a set of resources within a sidelink resource pool 1302. In some aspects, 2302 may be performed by the sensing component 2442 of FIG. 24.

At 2304, the UE may select a first subset of resources associated with a first RSRP above a first threshold within the set of resources or select a second subset of resources associated with a second RSRP above a second threshold within the set of resources. For example, the UE 402 may select a first subset of resources (e.g., including the resource 1414) associated with a first RSRP above a first threshold within the set of resources or select a second subset of resources associated with a second RSRP above a second threshold within the set of resources (e.g., including the resource in 912). The first subset of resources may be outside a random selection resource set available for one or more random selection UEs. The second subset of resources may be within the random selection resource set. In some aspects, 2304 may be performed by the sensing component 2442 of FIG. 24.

At 2306, the UE may transmit a sidelink transmission using the first subset of resources or the second subset of resources. For example, the UE 402 may transmit a sidelink transmission using the first subset of resources (e.g., including the resource 1414) or the second subset of resources (e.g., including the resource in 912). In some aspects, 2306 may be performed by the sidelink component 2444 of FIG. 24.

FIG. 24 is a diagram 2400 illustrating an example of a hardware implementation for an apparatus 2402. The apparatus 2402 may be a UE, a component of a UE, or may implement UE functionality. In some aspects, the apparatus 2402 may include a cellular baseband processor 2404 (also referred to as a modem) coupled to a cellular RF transceiver 2422. In some aspects, the apparatus 2402 may further include one or more subscriber identity modules (SIM) cards 2420, an application processor 2406 coupled to a secure digital (SD) card 2408 and a screen 2410, a Bluetooth module 2412, a wireless local area network (WLAN) module 2414, a Global Positioning System (GPS) module 2416, or a power supply 2418. The cellular baseband processor 2404 communicates through the cellular RF transceiver 2422 with the UE 104 and/or BS 102/180. The cellular baseband processor 2404 may include a computer-readable medium/memory. The computer-readable medium/memory may be non-transitory. The cellular baseband processor 2404 is responsible for general processing, including the execution of software stored on the computer-readable medium/memory. The software, when executed by the cellular baseband processor 2404, causes the cellular baseband processor 2404 to perform the various functions described supra. The computer-readable medium/memory may also be used for storing data that is manipulated by the cellular baseband processor 2404 when executing software. The cellular baseband processor 2404 further includes a reception component 2430, a communication manager 2432, and a transmission component 2434. The communication manager 2432 includes the one or more illustrated components. The components within the communication manager 2432 may be stored in the computer-readable medium/memory and/or configured as hardware within the cellular baseband processor 2404. The cellular baseband processor 2404 may be a component of the UE 350 and may include the memory 360 and/or at least one of the TX processor 368, the RX processor 356, and the controller/processor 359. In one configuration, the apparatus 2402 may be a modem chip and include the cellular baseband processor 2404, and in another configuration, the apparatus 2402 may be the entire UE (e.g., sec 350 of FIG. 3) and include the additional modules of the apparatus 2402.

The communication manager 2432 may include a sensing component 2442 that is configured to measure RSRP associated with a set of resources within a sidelink resource pool and select a first subset of resources associated with a first RSRP above a first threshold within the set of resources or select a second subset of resources associated with a second RSRP above a second threshold within the set of resources, e.g., as described in connection with 2302 or 2304 of FIG. 23. The communication manager 2432 may further include a sidelink component 2444 that may be configured to transmit a sidelink transmission using the first subset of resources or the second subset of resources, e.g., as described in connection with 2306 of FIG. 23.

The apparatus may include additional components that perform each of the blocks of the algorithm in the flowchart of FIG. 23. As such, each block in the flowchart of FIG. 23 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2402 may include a variety of components configured for various functions. In one configuration, the apparatus 2402, and in particular the cellular baseband processor 2404, may include means for measuring RSRP associated with a set of resources within a sidelink resource pool. The cellular baseband processor 2404 may further include means for selecting a first subset of resources associated with a first RSRP above a first threshold within the set of resources or select a second subset of resources associated with a second RSRP above a second threshold within the set of resources. The first subset of resources may be outside a random selection resource set available for one or more random selection UEs, the second subset of resources may be within the random selection resource set. The cellular baseband processor 2404 may further include means for transmitting a sidelink transmission using the first subset of resources or the second subset of resources. The means may be one or more of the components of the apparatus 2402 configured to perform the functions recited by the means. As described supra, the apparatus 2402 may include the TX Processor 368, the RX Processor 356, and the controller/processor 359. As such, in one configuration, the means may be the TX Processor 368, the RX Processor 356, and the controller/processor 359 configured to perform the functions recited by the means.

Example aspects provided herein may facilitate avoiding resource collision between random selection and partial/full sensing UEs. By configuring a random selection resource set that may be available for random selection UEs, the random selection UEs may avoid transmitting outside the random selection resource set that may collide with transmissions from partial/full sensing UEs. By configuring the random selection resource set to be also available for the sensing UEs, waste of resources may be avoided when there are no or few random selection UEs in an area.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.
Aspect 1 is an apparatus for wireless communication at a UE, including: a memory; and at least one processor coupled to the memory and, based at least in part on information stored in the memory, the at least one processor is configured to :: select a first sidelink transmission resource for SPS based on a sidelink sensing procedure for UE-to-UE communication, the first sidelink transmission resource being associated with one or more subchannels within one or more slots; initiate a timer based on a timer range, the timer range being based on one or more of a battery level or a mobility associated with the UE; and reselect a second sidelink transmission resource or maintain the first sidelink transmission resource for the UE-to-UE communication upon expiration of the timer.
Aspect 2 is the apparatus of aspect 1, where the timer range is associated with a maximum value and a minimum value, the maximum value or the minimum value being negatively correlated with at least one of the mobility or the battery level associated with the UE.
Aspect 3 is the apparatus of any of aspects 1-2, where the at least one processor is further configured to: change the minimum value or the maximum value based on the mobility being less than a mobility threshold or the battery level being less than a battery threshold.
Aspect 4 is the apparatus of any of aspects 1-3, where the at least one processor is further configured to decrease the timer upon transmitting a packet using the first sidelink transmission resource.
Aspect 5 is the apparatus of any of aspects 1-4, where the at least one processor is further configured to: receive, from each of one or more UEs, an indication of a mobility associated with the UE, where the timer range is further based on the mobility for each of the one or more UEs, and where the timer range is associated with a maximum value and a minimum value, the maximum value or the minimum value being negatively correlated with the one or more mobility associated with the one or more UEs.
Aspect 6 is the apparatus of any of aspects 1-5, where the at least one processor is further configured to: determine, upon expiration of the timer, whether to reselect the second sidelink transmission resource or maintain the first sidelink transmission resource based on a probability being within a probability range.
Aspect 7 is the apparatus of any of aspects 1-6, where the at least one processor is further configured to: receive, from each of one or more UEs, an indication of a mobility associated with the UE, where the probability range is further based on the mobility for each of the one or more UEs.
Aspect 8 is the apparatus of any of aspects 1-7, where a maximum value associated with the probability range is negatively correlated with at least one of the mobility or the battery level associated with the UE.
Aspect 9 is the apparatus of any of aspects 1-8, where the at least one processor is further configured to: change the maximum value based on the mobility being less than a mobility threshold or the battery level being less than a battery threshold.
Aspect 10 is the apparatus of any of aspects 1-9, where to change the maximum value, the at least one processor is further configured to: change the maximum value to be greater than 0.8.
Aspect 11 is the apparatus of any of aspects 1-10, where the timer range or the probability range is further based on one or more of: a system channel loading congestion level, a total number of resource associated with the first sidelink transmission resource, or a priority of the UE-to-UE communication.
Aspect 12 is the apparatus of any of aspects 1-11, where the at least one processor is further configured to: receive, from a base station via RRC, a configuration for the probability range or the timer range.
Aspect 13 is the apparatus of any of aspects 1-12, where a SCI-based pre-emption associated with the first sidelink transmission resource or the second sidelink transmission resource is disabled for the UE.
Aspect 14 is the apparatus of any of aspects 1-13, further including a transceiver or an antenna coupled to the at least one processor.
Aspect 15 is a method of wireless communication for implementing any of aspects 1 to 14.
Aspect 16 is an apparatus for wireless communication including means for implementing any of aspects 1 to 14.
Aspect 17 is a non-transitory computer-readable medium storing computer executable code, where the code when executed by a processor causes the processor to implement any of aspects 1 to 14.
Aspect 18 is an apparatus for wireless communication at a UE, including: a memory; and at least one processor coupled to the memory and configured to: select randomly a resource in a random selection resource set including one or more subchannels within one or more slots, the random selection resource set being within a sidelink resource pool for UE-to-UE communication and being available for a sidelink sensing procedure for the UE-to-UE communication; and transmit a sidelink transmission in the resource.
Aspect 19 is the apparatus of aspect 18, where the at least one processor is further configured to: select randomly a subsequent resource in the random selection resource set for one or more subsequent sidelink transmissions.
Aspect 20 is the apparatus of aspects 18-19, where the sidelink transmission is an initial transmission, and where the at least one processor is further configured to: select randomly a subsequent resource in the sidelink resource pool for one or more subsequent sidelink retransmissions associated with the initial transmission.
Aspect 21 is the apparatus of any of aspects 18-20, where the sidelink transmission is an initial transmission, where the at least one processor is further configured to: measure RSRP associated with a set of resources within the sidelink resource pool within a sensing time window; and select a subsequent resource from a subset of resources associated with an RSRP below a threshold within the set of resources for one or more subsequent sidelink retransmissions associated with the initial transmission.
Aspect 22 is the apparatus of any of aspects 18-21, where the random selection resource set is periodic, and where the at least one processor is further configured to: reserve a set of periodic resources including the resource by transmitting a first stage SCI.
Aspect 23 is the apparatus of any of aspects 18-22, where the at least one processor is further configured to: transmit an indication indicating whether the UE will transmit in a second resource of the set of periodic resources.
Aspect 24 is the apparatus of any of aspects 18-23, where the at least one processor is further configured to: receive, from a base station, a periodicity associated with the random selection resource set.
Aspect 25 is the apparatus of any of aspects 18-24, where a periodicity associated with the random selection resource set is negatively correlated with a total number of random selection UEs within an area or a CBR associated with the random selection resource set.
Aspect 26 is the apparatus of any of aspects 18-25, where a number of resources associated with the random selection resource set is positively correlated with a total number of random selection UEs within an area or a CBR associated with the random selection resource set.
Aspect 27 is the apparatus of any of aspects 18-26, further including a transceiver or an antenna coupled to the at least one processor.
Aspect 28 is an apparatus for wireless communication at a UE, including: a memory; and at least one processor coupled to the memory and configured to: measure RSRP associated with a set of resources within a sidelink resource pool; select a first subset of resources associated with a first RSRP above a first threshold within the set of resources or select a second subset of resources associated with a second RSRP above a second threshold within the set of resources, the first subset of resources being outside a random selection resource set available for one or more random selection UEs, the second subset of resources being within the random selection resource set; and transmit a sidelink transmission using the first subset of resources or the second subset of resources.
Aspect 29 is the apparatus of aspect 28, further including a transceiver or an antenna coupled to the at least one processor.
Aspect 30 is a method of wireless communication for implementing any of aspects 1 to 29.
Aspect 31 is an apparatus for wireless communication including means for implementing any of aspects 1 to 29.
Aspect 32 is a non-transitory computer-readable medium storing computer executable code, where the code when executed by a processor causes the processor to implement any of aspects 1 to 29.

What is claimed is:

1. An apparatus for wireless communication at a user equipment (UE), comprising:
a memory; and
at least one processor coupled to the memory and, based at least in part on information stored in the memory, the at least one processor is configured to:
select a first sidelink transmission resource for semi-persistent scheduling (SPS) based on a sidelink sensing procedure for UE-to-UE communication, the first sidelink transmission resource being associated with one or more subchannels within one or more slots;
initiate a timer based on a timer range, the timer range being based on one or more of a battery level or a mobility associated with the UE; and
reselect a second sidelink transmission resource or maintain the first sidelink transmission resource for the UE-to-UE communication upon an expiration of the timer.

2. The apparatus of claim 1, wherein the timer range is associated with a maximum value and a minimum value, the maximum value or the minimum value being negatively correlated with at least one of the mobility or the battery level associated with the UE.

3. The apparatus of claim 2, wherein the at least one processor is further configured to:
change the minimum value or the maximum value based on the mobility being less than a mobility threshold or the battery level being less than a battery threshold.

4. The apparatus of claim 3, wherein the at least one processor is further configured to decrease the timer upon transmitting a packet using the first sidelink transmission resource.

5. The apparatus of claim 1, wherein the at least one processor is further configured to:
receive, from each of one or more UEs, an indication of the mobility associated with the UE, wherein the timer range is further based on the mobility for each of the one or more UEs, and wherein the timer range is associated with a maximum value and a minimum value, the maximum value or the minimum value being negatively correlated with the mobility for each of the one or more UEs.

6. The apparatus of claim 1, wherein the at least one processor is further configured to:
determine, upon the expiration of the timer, whether to reselect the second sidelink transmission resource or maintain the first sidelink transmission resource based on a probability being within a probability range.

7. The apparatus of claim 6, wherein the at least one processor is further configured to:
receive, from each of one or more UEs, an indication of the mobility associated with the UE, wherein the probability range is further based on the mobility for each of the one or more UEs.

8. The apparatus of claim 6, wherein a maximum value associated with the probability range is negatively correlated with at least one of the mobility or the battery level associated with the UE.

9. The apparatus of claim 8, wherein the at least one processor is further configured to:
change the maximum value based on the mobility being less than a mobility threshold or the battery level being less than a battery threshold.

10. The apparatus of claim 9, wherein to change the maximum value, the at least one processor is further configured to:
change the maximum value to be greater than 0.8.

11. The apparatus of claim 6, wherein the timer range or the probability range is further based on one or more of: a system channel loading congestion level, a total number of resources associated with the first sidelink transmission resource, or a priority of the UE-to-UE communication.

12. The apparatus of claim 6, wherein the at least one processor is further configured to:
receive, from a base station via radio resource control (RRC), a configuration for the probability range or the timer range.

13. The apparatus of claim 1, wherein a sidelink control information (SCI) based pre-emption associated with the first sidelink transmission resource or the second sidelink transmission resource is disabled for the UE.

14. The apparatus of claim 1, further comprising a transceiver or an antenna coupled to the at least one processor.

15. A method for wireless communication at a user equipment (UE), comprising:
selecting a first sidelink transmission resource for semi-persistent scheduling (SPS) based on a sidelink sensing procedure for UE-to-UE communication, the first sidelink transmission resource being associated with one or more subchannels within one or more slots;
initiating a timer based on a timer range, the timer range being based on one or more of a battery level or a mobility associated with the UE; and
reselecting a second sidelink transmission resource or maintain the first sidelink transmission resource for the UE-to-UE communication upon an expiration of the timer.

16. The method of claim 15, wherein the timer range is associated with a maximum value and a minimum value, the maximum value or the minimum value being negatively correlated with at least one of the mobility or the battery level associated with the UE.

17. The method of claim 16, further comprising:
changing the minimum value or the maximum value based on the mobility being less than a mobility threshold or the battery level being less than a battery threshold.

18. The method of claim 17, further comprising decreasing the timer upon transmitting a packet using the first sidelink transmission resource.

19. An apparatus for wireless communication at a user equipment (UE), comprising:
a memory; and
at least one processor coupled to the memory and, based at least in part on information stored in the memory, the at least one processor is configured to:
select randomly a resource in a random selection resource set comprising one or more subchannels within one or more slots, the random selection resource set being within a sidelink resource pool for UE-to-UE communication and being available for a sidelink sensing procedure for the UE-to-UE communication; and
transmit a sidelink transmission in the resource.

20. The apparatus of claim 19, wherein the at least one processor is further configured to:
select randomly a subsequent resource in the random selection resource set for one or more subsequent sidelink transmissions.

21. The apparatus of claim 19, wherein the sidelink transmission is an initial transmission, and wherein the at least one processor is further configured to:
select randomly a subsequent resource in the sidelink resource pool for one or more subsequent sidelink retransmissions associated with the initial transmission.

22. The apparatus of claim 19, wherein the sidelink transmission is an initial transmission, wherein the at least one processor is further configured to:
measure a reference signal received power (RSRP) associated with a set of resources within the sidelink resource pool within a sensing time window; and
select a subsequent resource from a subset of resources associated with the RSRP being below a threshold within the set of resources for one or more subsequent sidelink retransmissions associated with the initial transmission.

23. The apparatus of claim 19, wherein the random selection resource set is periodic, and wherein the at least one processor is further configured to:
reserve a set of periodic resources comprising the resource by transmitting a first stage sidelink control information (SCI).

24. The apparatus of claim 23, wherein the at least one processor is further configured to:
transmit an indication indicating whether the UE will transmit in a second resource of the set of periodic resources.

25. The apparatus of claim 23, wherein the at least one processor is further configured to:
receive, from a base station, a periodicity associated with the random selection resource set.

26. The apparatus of claim 23, wherein a periodicity associated with the random selection resource set is negatively correlated with a total number of random selection UEs within an area or a channel busy ratio (CBR) associated with the random selection resource set.

27. The apparatus of claim 19, wherein a number of resources associated with the random selection resource set is positively correlated with a total number of random selection UEs within an area or a channel busy ratio (CBR) associated with the random selection resource set.

28. The apparatus of claim 19, further comprising a transceiver or an antenna coupled to the at least one processor.

29. An apparatus for wireless communication at a user equipment (UE), comprising:
a memory; and
at least one processor coupled to the memory and, based at least in part on information stored in the memory, the at least one processor is configured to:
measure reference signal received power (RSRP) associated with a set of resources within a sidelink resource pool;
select a first subset of resources associated with a first RSRP above a first threshold within the set of resources or select a second subset of resources associated with a second RSRP above a second threshold within the set of resources, the first subset of resources being outside a random selection resource set available for one or more random selection UEs, the second subset of resources being within the random selection resource set; and
transmit a sidelink transmission using the first subset of resources or the second subset of resources.

30. The apparatus of claim 29, further comprising a transceiver or an antenna coupled to the at least one processor.
